(19) United States
(12) Patent Application Publication
(10) Pub. No.: US 2026/0253028 A1
(43) Pub. Date: Aug. 27, 2026

(54) SYSTEM

(71) Applicant: SoftBank Group Corp., Tokyo (JP)

(72) Inventor: Yoshikazu OKADA, Tokyo (JP)

(73) Assignee: SoftBank Group Corp., Tokyo (JP)

(21) Appl. No.: 19/537,565

(22) Filed: Feb. 12, 2026

(30) Foreign Application Priority Data
Feb. 21, 2025 (JP) 2025-027048

(51) Int. Cl. G06Q 10/087

(52) U.S. Cl. CPC G06Q 10/087

(57) ABSTRACT

The system according to the embodiment comprises an analysis unit, a generation unit, a provision unit, and a cooking unit. The analysis unit analyzes a recipe or a cooking video. The generation unit generates ingredients and cooking procedures based on information analyzed by the analysis unit. The provision unit provides information generated by the generation unit to a robot. The cooking unit performs cooking based on information provided by the provision unit.

### CROSS-REFERENCE TO RELATED APPLICATION

The present application claims priority to and incorporates by reference the entire contents of Japanese Patent Application No. 2025-027048 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that cooking requires effort and time, and issues such as labor shortages and anxiety about cooking have not been sufficiently resolved.

### SUMMARY OF THE INVENTION

The system according to the embodiment comprises an analysis unit, a generation unit, a provision unit, and a cooking unit. The analysis unit analyzes a recipe or a cooking video. The generation unit generates ingredients and cooking procedures based on information analyzed by the analysis unit. The provision unit provides information generated by the generation unit to a robot. The cooking unit performs cooking based on information provided by the provision unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi®, or Bluetooth®, among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

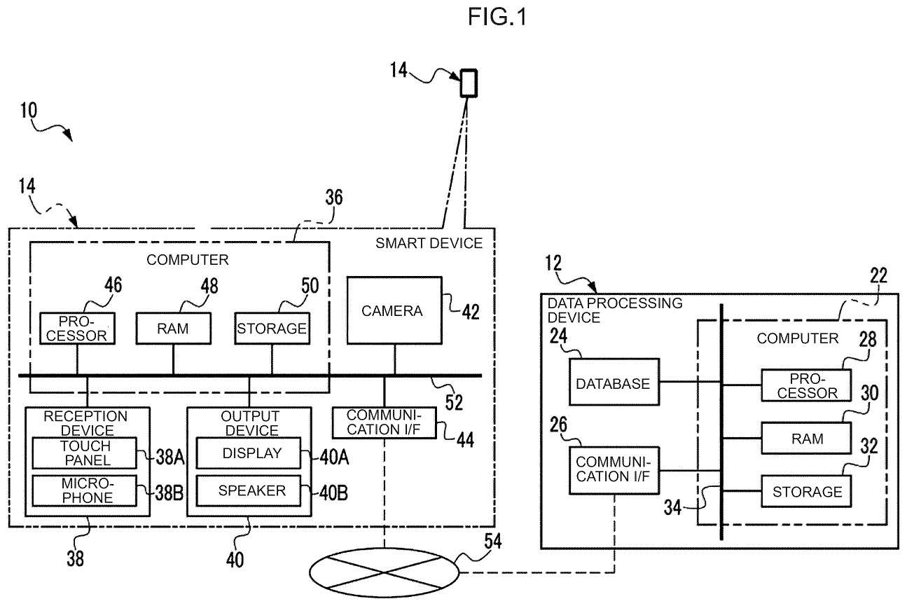

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

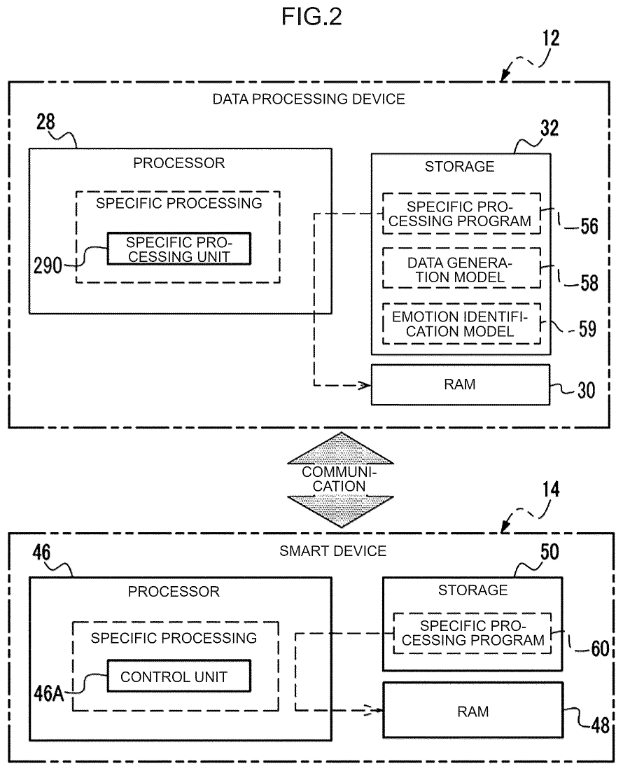

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE OF THE EMBODIMENT

The cooking assistance system according to the embodiment of the present invention is a system designed to address issues such as labor shortages, lack of time, and anxiety about cooking. This cooking assistance system utilizes AI to learn recipes and cooking videos, automatically generates ingredients and cooking procedures, and instructs a robot to provide high-quality dishes. For example, the cooking assistance system analyzes a large amount of recipe data and cooking videos using AI to understand the ingredients and cooking procedures for each dish. For instance, when the AI learns a pasta recipe, it analyzes the ingredients and cooking procedures in detail to understand how to cook the dish. Next, based on the information learned by the AI, ingredients and cooking procedures are automatically generated. For example, after the AI learns a pasta recipe, if the user inputs “I want to make pasta,” the AI automatically generates the necessary ingredients and cooking procedures, allowing the user to easily start cooking. Based on the generated ingredients and cooking procedures, the robot performs the cooking. The robot prepares the ingredients and cooks according to the instructions generated by the AI. For example, when the robot makes pasta, it prepares the ingredients based on the list generated by the AI and cooks the pasta according to the cooking procedures. This enables the provision of high-quality dishes. Through this mechanism, issues such as labor shortages, lack of time, and anxiety about cooking can be resolved. Since the robot cooks according to the ingredients and procedures generated by the AI, the user can reduce the effort required for cooking. Additionally, because the ingredients and procedures are automatically generated based on the information learned by the AI, the quality of the dishes can be consistently maintained. For example, even busy dual-income households or people who are not good at cooking can easily enjoy high-quality dishes. Thus, the cooking assistance system can resolve labor shortages, lack of time, and cooking anxiety, and provide high-quality dishes to users. Specifically, this cooking assistance system is composed of multiple modules, including an analysis unit, a generation unit, a provision unit, and a cooking unit, which operate in coordination. The system uses large language models, convolutional neural networks (CNN), recurrent neural networks (RNN), or Transformer architectures in the analysis unit to receive recipe text and cooking video image frames (e.g., 224×224 pixel RGB image tensors, 30 frames/sec), audio data (e.g., 16 kHz sampled waveform data), and structured ingredient lists (e.g., tables of ingredient names, quantities, units) as input. Examples of input include “recipe text for tomato sauce pasta,” “sequential image frames from a pasta cooking video,” and “ingredient list: 100 g pasta, 2 tomatoes, 1 tablespoon olive oil.” The analysis unit preprocesses these data (e.g., resizing and normalizing images, tokenizing text, converting audio to spectrograms), generates feature vectors for ingredients and cooking procedures through feature extraction layers, and analyzes the temporal flow of cooking steps and relationships between ingredients in high-dimensional space using attention mechanisms and sequence modeling. The analysis results are output as candidate ingredient lists (e.g., pasta, tomato, olive oil) and cooking procedure sequences (e.g., “1. Boil pasta,” “2. Sauté tomatoes,” “3. Mix with sauce”). The generation unit receives the output from the analysis unit and uses conditional generation models (e.g., conditional Transformer, Seq2Seq models) to automatically generate optimal ingredient lists and cooking procedures, considering additional parameters such as user input (e.g., “I want to make pasta”), refrigerator inventory information, allergy information, and preference information. Examples of output from the generation unit include “ingredient list: 100 g pasta, 2 tomatoes, 1 tablespoon olive oil” and “cooking procedures: 1. Boil pasta 2. Sauté tomatoes 3. Mix with sauce.” These outputs are used for subsequent processing such as threshold judgment (e.g., checking ingredient inventory, allergen detection), matching score calculation with user preferences, and generation of control commands for the cooking robot. The provision unit transmits the output from the generation unit to the cooking robot via communication protocols (e.g., MQTT, HTTP REST API), and the cooking unit controls hardware such as robot arms, heating devices, and measuring devices based on the received ingredient list and cooking procedures to perform actual cooking. The cooking unit acquires sensor data (e.g., temperature sensors, weight sensors, image sensors) in real time, performs anomaly detection and progress estimation using AI, and optimizes the cooking process. This enables an automated cooking process in a rule-based and high-dimensional feature space, independent of conventional human experience and manual work. The technical effects of this system include standardization, acceleration, and stabilization of cooking processes through large-scale data analysis and automatic generation by AI, and coordination with robot control, resulting in reduced human resources, decreased cooking errors, personalized support for each user, and optimization through linkage with ingredient inventory and health information, thereby improving computer technology itself. Specific application fields include home cooking assistance robots, automated cooking lines in restaurants, individualized meal support systems in nursing homes and hospitals, and cooking learning support in educational settings.

The cooking assistance system according to the embodiment comprises an analysis unit, a generation unit, a provision unit, and a cooking unit. The analysis unit analyzes recipes or cooking videos. For example, the analysis unit uses AI to analyze recipes and cooking videos and understand the ingredients and cooking procedures for each dish. For instance, the analysis unit uses image analysis technology to analyze the content of cooking videos and extract ingredients and cooking procedures. The analysis unit can also use text analysis technology to analyze the content of recipes and extract ingredients and cooking procedures. For example, the analysis unit performs image analysis on each frame of a cooking video to identify the types of ingredients and cooking procedures. Text analysis technology analyzes recipe text data to extract ingredient lists and cooking procedures. The generation unit generates ingredients and cooking procedures based on information analyzed by the analysis unit. For example, the generation unit uses AI to automatically generate ingredients and cooking procedures. For instance, when the user inputs “I want to make pasta,” the AI automatically generates the necessary ingredients and cooking procedures. The generation unit can also store the generated ingredients and cooking procedures. For example, the generation unit stores the generated ingredient list and cooking procedures in a database for later reference. The provision unit provides the information generated by the generation unit to the robot. For example, the provision unit transmits the generated ingredient list and cooking procedures to the robot. The provision unit provides information to the robot using communication protocols. The cooking unit performs cooking based on the information provided by the provision unit. For example, the cooking unit uses a robot to prepare ingredients and perform cooking. For instance, the cooking unit prepares ingredients based on the ingredient list generated by the AI and cooks according to the cooking procedures. Thus, the cooking assistance system according to the embodiment can analyze recipes and cooking videos, generate ingredients and cooking procedures, provide them to a robot, and perform cooking. Some or all of the above-described processing in the cooking unit may be performed using AI or without using AI. For example, the cooking unit may input the ingredient list and cooking procedures to the robot, and the robot can automatically perform cooking. This enables the cooking assistance system to provide high-quality dishes to users. Specifically, the cooking assistance system uses large language models, convolutional neural networks (CNN), recurrent neural networks (RNN), or Transformer architectures in the analysis unit to receive recipe text (e.g., Japanese or English natural language sentences, up to 4096 tokens), cooking video image frames (e.g., 224×224 pixel RGB image tensors, 30 frames/sec), audio data (e.g., 16kHz sampled waveform data, 960,000 samples for 1 minute of audio), and structured ingredient lists (e.g., tables of ingredient names, quantities, units) as input. Examples of input include “recipe text for tomato sauce pasta,” “sequential image frames from a pasta cooking video,” and “ingredient list: 100 g pasta, 2tomatoes, 1 tablespoon olive oil.” The analysis unit preprocesses these data (e.g., resizing and normalizing images, tokenizing text, converting audio to spectrograms), generates feature vectors for ingredients and cooking procedures through feature extraction layers (e.g., image feature extraction by CNN, text feature extraction by BERT, audio feature extraction by MFCC), and analyzes the temporal flow of cooking steps and relationships between ingredients in high-dimensional space using attention mechanisms and sequence modeling (e.g., LSTM, Transformer Encoder-Decoder). The analysis results are output as candidate ingredient lists (e.g., pasta, tomato, olive oil) and cooking procedure sequences (e.g., “1. Boil pasta,” “2. Sauté tomatoes,” “3. Mix with sauce”). The generation unit receives the output from the analysis unit and uses conditional generation models (e.g., conditional Transformer, Seq2Seq models) to automatically generate optimal ingredient lists and cooking procedures, considering additional parameters such as user input (e.g., “I want to make pasta”), refrigerator inventory information (e.g., inventory table “pasta: 120 g, tomato: 3”), allergy information (e.g., egg allergy), and preference information (e.g., spiciness level 3). Examples of output from the generation unit include “ingredient list: 100g pasta, 2 tomatoes, 1 tablespoon olive oil” and “cooking procedures: 1. Boil pasta 2. Sauté tomatoes 3. Mix with sauce.” These outputs are used for subsequent processing such as threshold judgment (e.g., checking ingredient inventory, allergen detection), matching score calculation with user preferences, and generation of control commands for the cooking robot. The provision unit transmits the output from the generation unit to the cooking robot via communication protocols (e.g., MQTT, HTTP REST API), and the cooking unit controls hardware such as robot arms, heating devices, and measuring devices based on the received ingredient list and cooking procedures to perform actual cooking. The cooking unit acquires sensor data (e.g., temperature sensors, weight sensors, image sensors) in real time, performs anomaly detection and progress estimation using AI, and optimizes the cooking process. Inputs to the AI include continuous image tensors from image sensors (e.g., 224×224×3×60), time-series data from temperature sensors (e.g., one point per second, total 600 points), and waveform data from audio sensors (e.g., 10 seconds of audio). The AI uses these inputs to perform anomaly detection (e.g., detection of burning, detection of insufficient heating) and progress estimation (e.g., judgment of boiling completion). The AI outputs structured data such as anomaly labels (e.g., “burning”), progress scores (e.g., 0.85), and estimated completion times (e.g., 12:34:56), which are input to the control logic of the cooking unit, and branching processes such as extension of heating time or addition of stirring operations are executed as needed. This enables an automated cooking process in a rule-based and high-dimensional feature space, independent of conventional human experience and manual work. The technical effects of this system include standardization, acceleration, and stabilization of cooking processes through large-scale data analysis and automatic generation by AI, and coordination with robot control, resulting in reduced human resources, decreased cooking errors, personalized support for each user, and optimization through linkage with ingredient inventory and health information, thereby improving computer technology itself. Specific application fields include home cooking assistance robots, automated cooking lines in restaurants, individualized meal support systems in nursing homes and hospitals, and cooking learning support in educational settings.

The analysis unit comprises a collection unit configured to collect recipes or cooking videos. The collection unit, for example, uses web scraping technology to collect recipes and cooking videos from the Internet. For instance, the collection unit automatically acquires recipe data from specific websites and stores it in a database. The collection unit can also acquire data using APIs. For example, the collection unit uses the API of a cooking video platform to obtain the latest cooking videos. Thus, the analysis unit can use the collection unit to collect recipes and cooking videos, thereby increasing the information available for analysis. Some or all of the above-described processing in the collection unit may be performed using AI or without using AI. For example, the collection unit can use web scraping tools to collect recipe data and store it in a database. Specifically, the analysis unit comprises multiple submodules as the collection unit, such as a web scraping module, API integration module, data normalization module, and duplicate elimination module, which operate in coordination. The web scraping module uses HTML parsers and regular expression engines to extract structured data such as recipe titles, ingredient lists, cooking procedures, image URLs, and video URLs from the DOM structure of recipe sites. The API integration module is equipped with OAuth authentication and API key management functions and regularly acquires recipe data in JSON or XML format from cooking video platforms and recipe databases using REST API or GraphQL API. The data normalization module automatically performs unit unification (e.g., g, ml, pieces), correction of notation variations (e.g., integration of “tomato” and “large tomato”), and language conversion (e.g., translation of English recipes into Japanese) for the acquired data. The duplicate elimination module uses hash value calculation and similarity determination algorithms (e.g., Jaccard coefficient, cosine similarity) to prevent duplicate registration of identical or similar recipes. When using AI, the collection unit uses natural language processing models (e.g., BERT, Transformer Encoder) to automatically remove noise from HTML or JSON and extract recipe structures. Examples of input to AI include “HTML source code (about 10,000 characters),” “API response JSON (structured data including recipe title, ingredients, procedures, image URL),” and “video metadata (title, tags, number of views).” The AI outputs structured data such as “ingredient list (e.g., 100 g pasta, 2 tomatoes, 1 tablespoon olive oil),” “cooking procedure sequence (e.g., 1. Boil pasta 2. Sauté tomatoes 3. Mix with sauce),” and “video URL.” The output data is used for subsequent processing such as storage in the database, duplicate elimination judgment, and transfer to the analysis unit. For training the AI model, manually annotated recipe datasets are used as teacher data, and loss functions such as cross-entropy loss and token-level F1 score are optimized. Thus, the collection unit, unlike conventional simple scraping or manual data collection, automates high-precision structuring, normalization, and duplicate elimination using AI, greatly improving collection efficiency and data quality. The technical effects of this configuration include comprehensive and high-precision collection of recipe and cooking video data, maintenance of database consistency and normalization, improvement of AI analysis accuracy through supply of high-quality data to the analysis unit, and realization of an autonomous data expansion and update cycle for the entire system, thereby improving computer technology itself. Specific application fields include automatic recipe expansion for home cooking assistance robots, automatic menu generation systems for restaurants, meal suggestion functions for health management apps, and educational cooking learning platforms.

The generation unit comprises a storage unit configured to store generated ingredients and cooking procedures. The storage unit, for example, uses a database to store generated ingredients and cooking procedures. For instance, the storage unit stores the generated ingredient list and cooking procedures in a database for later reference. The storage unit can also specify the storage format for saving data. For example, the storage unit can store data in JSON or XML format. Thus, the generation unit can use the storage unit to store generated ingredients and cooking procedures for later reference. Some or all of the above-described processing in the storage unit may be performed using AI or without using AI. For example, the storage unit can use a database management system to store data and retrieve it as needed. Specifically, the generation unit comprises multiple submodules as the storage unit, such as a relational database management system (RDBMS), NoSQL database, in-memory cache, version management module, and data encryption module, which operate in coordination. The storage unit stores structured data such as ingredient lists (e.g., table “ingredient ID, name, quantity, unit”), cooking procedures (e.g., table “procedure ID, description, required time, image URL”), user ID, and timestamp as metadata. Storage formats include JSON (e.g., {“ingredients”: [{“name”:“pasta”,“quantity”: 100,“unit”:“g”}],“procedures”: [{“description”:“Boil pasta”}]}), XML (e.g., <ingredients><item name=“pasta” quantity=“100” unit=“g”/></ingredients>), CSV, and binary formats. The version management module manages revision histories of the same recipe, enabling user customization and restoration of past versions. The data encryption module encrypts sensitive data such as user information and allergy information to enhance security. When using AI, the storage unit scores the importance and usage frequency of data to be stored using AI, automatically allocates data to storage hierarchies (e.g., high-speed SSD, low-speed HDD, cloud storage), and optimizes storage formats (e.g., images as WebP, text as compressed JSON). Examples of input to AI include “ingredient list (vector format: ingredient name, quantity, unit),” “cooking procedure sequence (text sequence with image URL),” and “user attributes (ID, preferences, allergy information).” The AI outputs “storage priority score (e.g., 0.92),” “recommended storage format (e.g., JSON),” and “storage selection (e.g., cloud),” which are input to the control logic of the storage unit. The output results are used for automatic selection of storage destination, data compression/encryption processing, and branching to version management. For training the AI model, past access logs and user behavior data are used as teacher data, and loss functions for optimizing storage efficiency and search speed are employed. Thus, the storage unit, unlike conventional simple data storage, automates dynamic storage optimization, security enhancement, and version management using AI, greatly improving data management efficiency and reliability. The technical effects of this configuration include efficient storage, search, and restoration of ingredient and cooking procedure data, personalized support for each user, secure data management, and improved scalability of the entire system, thereby improving computer technology itself. Specific application fields include recipe history management for home cooking assistance robots, menu history and revision management for restaurants, meal record storage for health management apps, and progress management for educational cooking learning platforms.

The cooking unit comprises an output unit configured to provide cooking results to a user. The output unit, for example, is equipped with a display or notification system for providing cooking results to the user. For instance, the output unit displays cooking results on a display to provide them visually to the user. The output unit can also send notifications to smartphones or tablets. For example, the output unit notifies the user's smartphone when cooking is completed. Thus, the cooking unit can use the output unit to provide cooking results to the user, allowing the user to check the results of cooking. Some or all of the above-described processing in the output unit may be performed using AI or without using AI. For example, the output unit can display cooking results on a display to provide them visually to the user. Specifically, the cooking unit comprises multiple submodules as the output unit, such as a high-resolution display module, voice notification module, mobile notification integration module, user interface optimization module, and real-time progress display module, which operate in coordination. The high-resolution display module graphically displays cooking completion images (e.g., 224×224 pixel RGB images), progress bars for cooking steps, ingredient lists, nutritional information, and more. The voice notification module notifies the user with synthesized voice when cooking is completed or when an anomaly occurs. The mobile notification integration module sends push notifications to smartphones or tablets via Bluetooth or Wi-Fi, allowing users to check cooking status even when away from home. The user interface optimization module automatically adjusts display layouts and color schemes according to the user's device information (screen size, resolution, OS) and preferences. The real-time progress display module dynamically displays the progress of each cooking step (e.g., heating, stirring, plating) and remaining time. When using AI, the output unit inputs the user's emotion, behavior history, and device information to AI, which automatically determines the optimal display method and notification timing. Examples of input to AI include “user's facial image (224×224 pixel RGB image),” “audio data (10 seconds of audio waveform),” “device information (screen size, OS),” and “past notification response history.” The AI outputs “display layout selection (e.g., simple, detailed),” “notification timing (e.g., immediately after cooking completion, 5 minutes before),” and “notification method (e.g., voice, vibration, push notification),” which are input to the control logic of the output unit. The output results are used for automatic switching of display, branching of notification methods, and collection of user feedback. For training the AI model, user response logs and satisfaction surveys are used as teacher data, and loss functions for display optimization and maximization of notification effectiveness are employed. Thus, the output unit, unlike conventional simple display and notification, automates personalized display, notification optimization, and real-time progress management using AI, greatly improving user experience and information transmission efficiency. The technical effects of this configuration include immediate and diverse notification of cooking results, optimized display for each user, real-time progress management, improved user satisfaction, and enhanced interaction efficiency for the entire system, thereby improving computer technology itself. Specific application fields include cooking completion notification for home cooking assistance robots, progress management for automated cooking lines in restaurants, meal record notification for health management apps, and progress feedback for educational cooking learning platforms.

The analysis unit is configured to estimate a user's emotion and select recipes or cooking videos to be analyzed based on the estimated emotion of the user. For example, the analysis unit captures the user's facial expression with a camera and estimates the emotion using an emotion estimation algorithm. For instance, the analysis unit calculates an emotion score based on changes in facial expression to estimate the user's emotion. The analysis unit can also record the user's voice and estimate the emotion using voice analysis technology. For example, the analysis unit analyzes the tone and speed of the voice to calculate an emotion score. Furthermore, the analysis unit can collect the user's biometric data (heart rate and skin conductance) with sensors and estimate the emotion using an emotion estimation algorithm. For example, the analysis unit calculates an emotion score based on heart rate fluctuations. Thus, the analysis unit can estimate the user's emotion and select recipes or cooking videos to be analyzed based on the estimated emotion. Emotion estimation is realized, for example, by using an emotion engine or generative AI with emotion estimation functions. Generative AI may be a text generation AI (e.g., LLM) or a multimodal generative AI, but is not limited to these examples. Some or all of the above-described processing in the analysis unit may be performed using AI or without using AI. For example, the analysis unit can input user image data captured by a camera to generative AI and have the generative AI perform emotion estimation. Specifically, the analysis unit integrally utilizes multiple sensor data for user emotion estimation. Input data includes 224×224 pixel RGB image tensors (e.g., 10 consecutive frames) obtained from a camera, 16 kHz sampled audio waveform data (e.g., 80,000 samples over 5 seconds) obtained from a microphone, and time-series biometric data (e.g., one point per second, total 60 points) from heart rate and skin conductance sensors. The analysis unit preprocesses these multimodal data (e.g., image normalization and face region extraction, audio spectrogram conversion, noise removal from biometric data), extracts facial features using convolutional neural networks (CNN), and extracts audio and biometric time-series features using recurrent neural networks (RNN) or Transformer. The extracted feature vectors are integrated in a multimodal fusion layer (e.g., attention mechanism or feature concatenation layer), and emotion labels such as “joy,” “sadness,” “stress,” “relaxation,” and continuous emotion scores (e.g., 0.78) are output by an emotion classification head (e.g., fully connected layer+Softmax). Examples of output include “emotion label: stress,” “emotion score: 0.65,” and “estimated confidence: 0.92.” The analysis unit selects appropriate candidates from the recipe and cooking video database based on these emotion estimation results. For example, if stress is high, “easy and quick recipes” or “healing cooking videos” are preferentially extracted, and if the user is relaxed, “challenge recipes” or “elaborate cooking videos” are selected. The selection algorithm calculates matching scores between recipe attributes (difficulty, cooking time, genre) and emotion labels, and extracts top candidates using rule-based or trained recommendation models (e.g., ranking learning models). AI-based emotion estimation and recipe selection processing, unlike conventional subjective human judgment or simple keyword search, combines pattern recognition in high-dimensional feature space with rule-based automatic selection to realize recipe recommendations optimized for the user's psychological state. The technical effects are that the analysis unit, through high-precision emotion estimation and automatic recipe selection by multimodal AI, greatly improves the degree of personalization of user experience, enhances the accuracy, speed, and consistency of recipe selection, and advances computer technology beyond simple automation. Specific application fields include emotion-adaptive recipe recommendation for home cooking assistance robots, stress care meal suggestions for health management apps, motivation-linked task presentation for educational cooking learning systems, and meal support according to psychological state in nursing facilities.

The analysis unit is configured to analyze nutritional value and calorie information of recipes during analysis and utilize such information for health management. For example, the analysis unit analyzes the nutritional value of recipes and proposes recipes tailored to the user's health condition. For instance, the analysis unit refers to a nutrition table and calculates the nutritional value of each ingredient. The analysis unit can also analyze calorie information of recipes and propose recipes suitable for users on a diet. For example, the analysis unit calculates calorie information using calorie calculation methods. Furthermore, the analysis unit analyzes the nutritional balance of recipes and proposes recipes to supplement nutritional deficiencies. For example, the analysis unit evaluates the balance of nutrients and proposes recipes with high nutritional value. Thus, the analysis unit can analyze nutritional value and calorie information of recipes and utilize such information for health management. Some or all of the above-described processing in the analysis unit may be performed using AI or without using AI. For example, the analysis unit can refer to a nutrition table and use AI to analyze nutritional value and calorie information. Specifically, the analysis unit receives recipe text (e.g., natural language sentences such as “100 g pasta, 2 tomatoes, 1 tablespoon olive oil”), ingredient lists (e.g., table format “ingredient name, quantity, unit”), and nutrition databases (e.g., tables storing nutrient values per 100 g for each ingredient) as input. Examples of input include “ingredient list: 100 g pasta, 2 tomatoes, 1 tablespoon olive oil,” and “nutrition table: pasta (150 kcal per 100 g, 5 g protein), tomato (20 kcal per piece, 15 mg vitamin C).” The analysis unit normalizes the quantity for each ingredient, matches it with the nutrition table, and calculates total values for calories, protein, fat, carbohydrates, vitamins, minerals, etc., in vector format (e.g., calories: 250 kcal, protein: 8 g, fat: 3 g, carbohydrates: 45 g). When using AI, the analysis unit uses natural language processing models (e.g., BERT, Transformer Encoder) to automatically correct notation variations and unit conversions for ingredient names, and uses nutrient estimation models (e.g., regression neural networks) to predict nutrient values for unknown ingredients. Examples of input to AI include “ingredient list vector” and “user health status data (e.g., BMI, allergy information, disease history),” and AI outputs “estimated nutrient vector,” “health score (e.g., 0.82),” and “recommended recipe label (e.g., for diet).” The output results are used for subsequent processing such as matching judgment with health status (e.g., calorie limit excess judgment, nutrition balance score calculation), recipe recommendation ranking, and linkage to health management apps. The analysis unit, unlike conventional manual calculation or simple calorie table reference, automates nutrient estimation, balance evaluation, and health status-linked recipe recommendation in high-dimensional feature space using AI, greatly improving the accuracy, speed, and degree of personalization in health management support. The technical effects are that the analysis unit, through AI-based nutritional value and calorie analysis and health status-linked recipe recommendation automation, realizes efficiency, accuracy improvement, and error reduction in health management, thereby improving computer technology itself. Specific application fields include health food suggestions for home cooking assistance robots, automatic menu generation for diet support apps, individual nutrition management in hospitals and nursing facilities, and nutrition optimization systems for athletes.

The analysis unit is configured to analyze cultural background and historical information of recipes during analysis and provide such information to the user. For example, the analysis unit analyzes the cultural background of recipes and explains the origin of the dish to the user. For instance, the analysis unit conducts literature research to identify the cultural background of the dish. The analysis unit can also analyze historical information of recipes and introduce the history of the dish to the user. For example, the analysis unit refers to historical literature and databases to identify the historical background of the dish. Furthermore, the analysis unit analyzes region-specific information of recipes and conveys the regional characteristics of the dish to the user. For example, the analysis unit analyzes region-specific ingredients and cooking methods and provides them to the user. Thus, the analysis unit can analyze cultural background and historical information of recipes and provide such information to the user. Some or all of the above-described processing in the analysis unit may be performed using AI or without using AI. For example, the analysis unit can conduct literature research and use AI to analyze cultural background and historical information. Specifically, the analysis unit receives recipe text (e.g., “Neapolitan recipe”), dish name, ingredient list, region information (e.g., country, region name), and external culinary culture and history databases (e.g., culinary encyclopedias, regional ingredient databases, historical timelines) as input. Examples of input include “dish name: Neapolitan,” “region: Japan,” “ingredients: pasta, ketchup, onion,” and “literature data: Neapolitan originated in postwar Japan.” The analysis unit uses natural language processing models (e.g., large language models, BERT, Transformer Encoder) to extract characteristic words such as origin, development history, regional characteristics, and representative ingredients/cooking methods from recipe text and literature data, and structures them as knowledge graphs or chronological timelines. Examples of input to AI include “recipe text,” “dish name,” “region information,” and “literature data (natural language sentences),” and AI outputs “cultural background explanation (e.g., Neapolitan is a Western-style pasta born in postwar Japan),” “historical timeline (e.g., born in 1945→popularized in the 1960s),” and “regional characteristic list (e.g., unique Japanese ketchup flavor).” The output results are used for subsequent processing such as displaying dish explanations in the user interface, generating educational content, and presenting background information during recipe recommendation. The analysis unit, unlike conventional manual research or simple keyword search, realizes comprehensive, accurate, and immediate knowledge extraction, structuring, and automatic summarization across large-scale literature and databases using AI, greatly improving the coverage, accuracy, and immediacy of cultural and historical information. The technical effects are that the analysis unit, through AI-based cultural and historical information analysis and automatic provision, enhances users' intellectual curiosity and motivation to learn, increases the added value of the cooking experience, promotes information utilization in diverse fields such as education, tourism, and regional development, and improves computer technology itself. Specific application fields include dish explanation functions for home cooking assistance robots, generation of historical teaching materials for educational cooking learning systems, regional dish introduction for tourist destinations, and storytelling support for restaurants.

The analysis unit is configured to estimate a user's emotion and adjust a display method of analysis results based on the estimated emotion of the user. For example, the analysis unit captures the user's facial expression with a camera and estimates the emotion using an emotion estimation algorithm. For instance, the analysis unit calculates an emotion score based on changes in facial expression to estimate the user's emotion. The analysis unit can also record the user's voice and estimate the emotion using voice analysis technology. For example, the analysis unit analyzes the tone and speed of the voice to calculate an emotion score. Furthermore, the analysis unit can collect the user's biometric data (heart rate and skin conductance) with sensors and estimate the emotion using an emotion estimation algorithm. For example, the analysis unit calculates an emotion score based on heart rate fluctuations. Thus, the analysis unit can estimate the user's emotion and adjust a display method of analysis results based on the estimated emotion. Emotion estimation is realized, for example, by using an emotion engine or generative AI with emotion estimation functions. Generative AI may be a text generation AI (e.g., LLM) or a multimodal generative AI, but is not limited to these examples. Some or all of the above-described processing in the analysis unit may be performed using AI or without using AI. For example, the analysis unit can input user image data captured by a camera to generative AI and have the generative AI perform emotion estimation. Specifically, the analysis unit receives, for user emotion estimation, 224×224 pixel RGB image tensors (e.g., 10 consecutive frames) obtained from a camera, 16 kHz sampled audio waveform data (e.g., 80,000 samples over 5 seconds) obtained from a microphone, and time-series biometric data (e.g., one point per second, total 60 points) from heart rate and skin conductance sensors. Examples of input include “consecutive frames of user's facial images,” “user's speech audio waveform,” and “time-series heart rate data.” The analysis unit preprocesses these multimodal data (e.g., image normalization and face region extraction, audio spectrogram conversion, noise removal from biometric data), extracts facial features using convolutional neural networks (CNN), and extracts audio and biometric time-series features using recurrent neural networks (RNN) or Transformer. The extracted feature vectors are integrated in a multimodal fusion layer (e.g., attention mechanism or feature concatenation layer), and emotion labels such as “joy,” “sadness,” “stress,” “relaxation,” and continuous emotion scores (e.g., 0.78) are output by an emotion classification head (e.g., fully connected layer+Softmax). Examples of output include “emotion label: relaxation,” “emotion score: 0.65,” and “estimated confidence: 0.92.” The analysis unit dynamically adjusts the display method of analysis results based on these emotion estimation results. For example, if the user is stressed, the analysis unit selects a simple and highly visible display layout, and if the user is relaxed, it displays detailed information and additional explanations. The analysis unit automatically adjusts UI parameters such as color scheme, font size, amount of information, and notification timing according to the emotion score. AI-based emotion estimation and display adjustment processing, unlike conventional subjective human judgment or fixed UI design, combines pattern recognition in high-dimensional feature space with rule-based automatic optimization to realize information presentation optimized for the user's psychological state. The technical effects are that the analysis unit, through high-precision emotion estimation and automatic optimization of display methods by multimodal AI, greatly improves the degree of personalization of user experience, enhances the efficiency, accuracy, and satisfaction of information transmission, and advances computer technology beyond simple automation. Specific application fields include emotion-adaptive UI for home cooking assistance robots, stress care information presentation for health management apps, motivation-linked progress display for educational cooking learning systems, and information provision according to psychological state in nursing facilities.

The analysis unit is configured to refer to a user's past cooking history during analysis and preferentially analyze recipes that match the user's preferences. For example, the analysis unit preferentially analyzes recipes that match the user's preferences based on dishes the user has cooked in the past. For instance, the analysis unit obtains the user's past cooking history from a database and identifies recipes that match the user's preferences. The analysis unit can also preferentially analyze recipes for dishes that the user frequently cooks based on past cooking history. For example, the analysis unit analyzes the user's cooking history to identify recipes for frequently cooked dishes. Furthermore, the analysis unit can analyze the user's past cooking history and propose new dishes. For example, the analysis unit proposes new recipes based on the user's preferences. Thus, the analysis unit can refer to a user's past cooking history during analysis and preferentially analyze recipes that match the user's preferences. Some or all of the above-described processing in the analysis unit may be performed using AI or without using AI. For example, the analysis unit can input cooking history obtained from a database to AI to identify recipes that match the user's preferences. Specifically, the analysis unit receives a user-specific cooking history database (e.g., structured tables including dish name, cooking date, evaluation score, frequency, ingredient list, cooking procedures, user feedback) as input. Examples of input include “cooking history: curry (5 times), pasta (3 times), salad (2 times),” “evaluation score: curry 4.5, pasta 4.0,” and “ingredient history: tomato, chicken, potato.” The analysis unit preprocesses these history data (e.g., normalization of dish names, integration of ingredient names, standardization of evaluation scores), generates a user preference vector through feature extraction layers (e.g., embedding layer, time-series aggregation layer), and uses collaborative filtering, content-based recommendation algorithms, or Transformer-based recommendation models to calculate similarity scores between the user's preference vector and feature vectors of each recipe in the recipe database. Examples of input to AI include “user preference vector” and “set of all recipe feature vectors,” and AI outputs “recipe list with recommendation scores (e.g., curry 0.95, pasta 0.90, salad 0.85)” and “new recipe proposal (e.g., tomato soup).” The output results are used for subsequent processing such as determining analysis priority, extracting recipes to be analyzed, and generating new proposal lists for the user. The analysis unit, unlike conventional manual history reference or simple frequency aggregation, automates preference estimation, recommendation score calculation, and new proposal generation in high-dimensional feature space using AI, greatly improving the degree of personalization, accuracy, and speed of recipe analysis. The technical effects are that the analysis unit, through AI-based history-referenced recipe recommendation and automatic analysis prioritization, improves user satisfaction, optimizes allocation of analysis resources, supports discovery of new recipes, and enhances the efficiency of the entire system, thereby improving computer technology itself. Specific application fields include personalized menu proposals for home cooking assistance robots, customer history-linked menu analysis for restaurants, preference history-linked meal suggestions for health management apps, and individual progress analysis for educational cooking learning systems.

The analysis unit is configured to preferentially analyze recipes according to the season or weather during analysis. For example, the analysis unit preferentially analyzes recipes using seasonal ingredients according to the season. For instance, the analysis unit refers to a list of seasonal ingredients to identify recipes using seasonal ingredients. The analysis unit can also preferentially analyze recipes for warm or cold dishes according to the weather. For example, the analysis unit refers to weather data to identify appropriate recipes. Furthermore, the analysis unit can preferentially analyze recipes for seasonal events. For example, the analysis unit identifies and analyzes recipes related to seasonal events. Thus, the analysis unit can preferentially analyze recipes according to the season or weather. Some or all of the above-described processing in the analysis unit may be performed using AI or without using AI. For example, the analysis unit can input lists of seasonal ingredients and weather data to AI to identify appropriate recipes. Specifically, the analysis unit receives structured data such as seasonal information (e.g., month, four seasons, holidays), weather data (e.g., temperature, humidity, weather type), list of seasonal ingredients (e.g., monthly ingredient table), and event calendar (e.g., New Year's, Christmas, cherry blossom viewing) as input. Examples of input include “current month: December,” “weather: snow, temperature 2° C.,” “seasonal ingredients: daikon, Chinese cabbage,” and “event: Christmas.” The analysis unit preprocesses these data (e.g., standardization of dates, conversion of weather codes, normalization of ingredient names), generates season, weather, and event feature vectors through feature extraction layers (e.g., embedding layer, category aggregation layer), and uses recommendation algorithms or conditional generation models (e.g., conditional Transformer) to calculate matching scores between attributes of each recipe in the recipe database (e.g., used ingredients, cooking temperature, cooking time, event tags) and input feature vectors. Examples of input to AI include “season/weather feature vector” and “set of all recipe attribute vectors,” and AI outputs “priority analysis recipe list (e.g., hot pot 0.95, stew 0.90, salad 0.60)” and “event-related recipe proposal (e.g., Christmas cake).” The output results are used for subsequent processing such as determining analysis priority, extracting recipes to be analyzed, and generating season/weather-linked proposal lists for the user. The analysis unit, unlike conventional human sense of season or simple calendar reference, realizes season, weather, and event-linked recipe recommendation and automatic analysis prioritization in high-dimensional feature space using AI, greatly improving the degree of personalization, immediacy, and coverage of recipe analysis. The technical effects are that the analysis unit, through AI-based season, weather, and event-linked recipe analysis automation, improves user satisfaction, reduces food waste, strengthens event responsiveness, and enhances the flexibility of the entire system, thereby improving computer technology itself. Specific application fields include season-linked menu proposals for home cooking assistance robots, weather-linked menu analysis for restaurants, seasonal ingredient suggestions for health management apps, and event-linked task presentation for educational cooking learning systems.

The generation unit is configured to estimate a user's emotion and adjust ingredients and cooking procedures to be generated based on the estimated emotion of the user. For example, the generation unit captures the user's facial expression with a camera and estimates the emotion using an emotion estimation algorithm. For instance, the generation unit calculates an emotion score based on changes in facial expression to estimate the user's emotion. The generation unit can also record the user's voice and estimate the emotion using voice analysis technology. For example, the generation unit analyzes the tone and speed of the voice to calculate an emotion score. Furthermore, the generation unit can collect the user's biometric data (heart rate and skin conductance) with sensors and estimate the emotion using an emotion estimation algorithm. For example, the generation unit calculates an emotion score based on heart rate fluctuations. Thus, the generation unit can estimate the user's emotion and adjust ingredients and cooking procedures to be generated based on the estimated emotion. Emotion estimation is realized, for example, by using an emotion engine or generative AI with emotion estimation functions. Generative AI may be a text generation AI (e.g., LLM) or a multimodal generative AI, but is not limited to these examples. Some or all of the above-described processing in the generation unit may be performed using AI or without using AI. For example, the generation unit can input user image data captured by a camera to generative AI and have the generative AI perform emotion estimation. Specifically, the generation unit receives, for user emotion estimation, 224×224 pixel RGB image tensors (e.g., 10 consecutive frames) obtained from a camera, 16kHz sampled audio waveform data (e.g., 80,000 samples over 5 seconds) obtained from a microphone, and time-series biometric data (e.g., one point per second, total 60 points) from heart rate and skin conductance sensors. Examples of input include “consecutive frames of user's facial images,” “user's speech audio waveform,” and “time-series heart rate data.” The generation unit preprocesses these multimodal data (e.g., image normalization and face region extraction, audio spectrogram conversion, noise removal from biometric data), extracts facial features using convolutional neural networks (CNN), and extracts audio and biometric time-series features using recurrent neural networks (RNN) or Transformer. The extracted feature vectors are integrated in a multimodal fusion layer (e.g., attention mechanism or feature concatenation layer), and emotion labels such as “joy,” “sadness,” “stress,” “relaxation,” and continuous emotion scores (e.g., 0.78) are output by an emotion classification head (e.g., fully connected layer+Softmax). Examples of output include “emotion label: relaxation,” “emotion score: 0.65,” and “estimated confidence: 0.92.” The generation unit uses these emotion estimation results and conditional generation models (e.g., conditional Transformer, Seq2Seq models) to dynamically adjust generation parameters for ingredient lists and cooking procedures. For example, if the user is stressed, the generation unit preferentially generates “easy, quick, and less error-prone” ingredients and procedures, and if the user is relaxed, it generates recipes including “new challenges and elaborate cooking steps.” The generation unit automatically adjusts the types of ingredients (e.g., ingredients with healing effects, ingredients with low cooking load), complexity of cooking procedures (e.g., number of steps, cooking time), and flavor tendencies (e.g., emphasis on sweetness or saltiness) according to the emotion score. AI-based emotion estimation, ingredient generation, and procedure adjustment processing, unlike conventional subjective human judgment or simple recipe selection, combines pattern recognition in high-dimensional feature space with rule-based automatic optimization to realize generation of ingredients and cooking procedures optimized for the user's psychological state. The technical effects are that the generation unit, through high-precision emotion estimation and automatic optimization of ingredient and procedure generation by multimodal AI, greatly improves the degree of personalization of user experience, enhances the efficiency, accuracy, and satisfaction of cooking processes, and advances computer technology beyond simple automation. Specific application fields include emotion-adaptive recipe generation for home cooking assistance robots, stress care meal suggestions for health management apps, motivation-linked task generation for educational cooking learning systems, and meal support according to psychological state in nursing facilities.

The generation unit is configured to generate ingredients in consideration of the user's allergy information during generation. For example, the generation unit generates ingredients excluding ingredients to which the user is allergic. For instance, the generation unit obtains the user's allergy information from a database and identifies ingredients that do not contain allergens. The generation unit can also propose alternative ingredients based on the user's allergy information. For example, the generation unit proposes ingredients that can be used instead of those containing allergens. Furthermore, the generation unit can generate safe ingredients in consideration of the user's allergy information. For example, the generation unit generates a list of ingredients that do not contain allergens and provides it to the user. Thus, the generation unit can generate ingredients in consideration of the user's allergy information and provide safe dishes. Some or all of the above-described processing in the generation unit may be performed using AI or without using AI. For example, the generation unit can input allergy information obtained from a database to AI to identify ingredients that do not contain allergens. Specifically, the generation unit receives user-specific allergy information (e.g., allergen list such as egg, milk, wheat, nuts, severity, history of past allergic reactions, etc., in a structured table) as input. Examples of input include “allergen list: egg, milk,” “severity: high,” and “past reaction: egg allergy occurred on 2019 May 1.” The generation unit preprocesses this allergy information (e.g., normalization of ingredient names, conversion to allergen classification codes, scoring of severity), matches it with the candidate ingredient list (e.g., all ingredient list output from the recipe analysis unit), and automatically excludes ingredients containing allergens. Furthermore, the generation unit refers to an alternative ingredient database (e.g., mapping table such as egg substitute→tofu, milk substitute→soy milk) for the ingredient list after allergen removal and automatically proposes alternative ingredients. When using AI, the generation unit utilizes natural language processing models (e.g., large language models, Transformer Encoder) and graph neural networks to automatically handle notation variations of ingredient names and decomposition of composite ingredients (e.g., mayonnaise=egg+oil+vinegar), and accurately determine the risk of allergen contamination. Examples of input to AI include “ingredient list vector (e.g., pasta, egg, milk, tomato)” and “user allergen vector (e.g., egg, milk),” and AI outputs “safe ingredient list (e.g., pasta, tomato),” “alternative proposal list (e.g., egg→tofu, milk→soy milk),” and “risk score (e.g., 0.01).” The output results are used for subsequent processing such as branching in ingredient list generation (e.g., automatic exclusion when allergens are present, user selection when alternative proposals are made), automatic adjustment of cooking procedures (e.g., switching to cooking methods without eggs), and safety notification to the user. For training the AI model, actual allergy incident data and ingredient composition databases are used as teacher data, and loss functions for minimizing false detection rate and maximizing safety are employed. Thus, the generation unit, unlike conventional simple ingredient exclusion or manual allergen checking, automates allergen detection, alternative proposal, and risk evaluation in high-dimensional feature space using AI, greatly improving the safety, accuracy, and degree of personalization in ingredient generation. The technical effects are that the generation unit, through AI-based allergy information-linked ingredient generation automation, reduces the risk of allergy incidents, optimizes safety for each user, diversifies ingredient proposals, and enhances the reliability of the entire system, thereby improving computer technology itself. Specific application fields include allergy-compatible recipe generation for home cooking assistance robots, allergen management systems for restaurants, automatic safe menu generation for school lunches, and individual allergy-compatible meal support in medical and nursing facilities.

The generation unit is configured to generate ingredients in consideration of the user's ingredient inventory information during generation. For example, the generation unit refers to the user's refrigerator inventory information to generate necessary ingredients. For instance, the generation unit uses an inventory management system to obtain the user's refrigerator inventory information and identify necessary ingredients. The generation unit can also propose alternative ingredients based on the user's ingredient inventory information. For example, the generation unit proposes ingredients that can be used instead of ingredients that are in short supply. Furthermore, the generation unit can generate ingredients without waste in consideration of the user's inventory information. For example, the generation unit generates a necessary ingredient list based on inventory information and proposes dishes without waste. Thus, the generation unit can generate ingredients in consideration of the user's ingredient inventory information and provide dishes without waste. Some or all of the above-described processing in the generation unit may be performed using AI or without using AI. For example, the generation unit can input inventory information obtained from an inventory management system to AI to identify necessary ingredients. Specifically, the generation unit receives user-specific inventory information (e.g., ingredient lists for refrigerator, pantry, freezer, quantity of each ingredient, expiration date, date of entry, etc., in a structured table) as input. Examples of input include “inventory list: 120 g pasta, 3 tomatoes, 50 ml olive oil,” and “expiration date: tomato 2024 Jun. 10.” The generation unit preprocesses this inventory information (e.g., normalization of ingredient names, unification of quantity units, calculation of remaining days until expiration), matches it with the candidate ingredient list output from the recipe analysis unit, preferentially selects ingredients with sufficient inventory, and automatically extracts ingredients that are lacking. Furthermore, the generation unit refers to an alternative ingredient database (e.g., mapping table such as pasta substitute→udon, tomato substitute→bell pepper) for ingredients that are lacking and automatically proposes substitute ingredients available in inventory. When using AI, the generation unit utilizes reinforcement learning models and conditional generation models (e.g., conditional Transformer) to optimize ingredient lists for inventory consumption efficiency and minimization of food waste. Examples of input to AI include “inventory vector (e.g., 120 g pasta, 3 tomatoes),” “recipe ingredient vector (e.g., 100g pasta, 2 tomatoes),” and AI outputs “optimal ingredient list (e.g., 100 g pasta, 2 tomatoes, 1 tablespoon olive oil),” “alternative proposal list (e.g., tomato→bell pepper),” and “waste reduction score (e.g., 0.95).” The output results are used for subsequent processing such as branching in ingredient list generation (e.g., selection of ingredients based on inventory availability, user selection when alternative proposals are made), automatic adjustment of cooking procedures (e.g., switching cooking methods when using substitute ingredients), and inventory consumption proposals to the user. For training the AI model, past inventory consumption history and food waste data are used as teacher data, and loss functions for minimizing waste and maximizing satisfaction are employed. Thus, the generation unit, unlike conventional simple inventory reference or manual ingredient selection, automates inventory optimization, alternative proposal, and waste reduction in high-dimensional feature space using AI, greatly improving the efficiency, accuracy, and degree of personalization in ingredient generation. The technical effects are that the generation unit, through AI-based inventory information-linked ingredient generation automation, reduces food waste, improves inventory consumption efficiency, optimizes for each user, and strengthens the sustainability of the entire system, thereby improving computer technology itself. Specific application fields include inventory-linked menu generation for home cooking assistance robots, inventory optimization menu proposals for restaurants, ingredient consumption support for health management apps, and food waste reduction platforms.

The generation unit is configured to estimate a user's emotion and adjust the difficulty level of recipes to be generated based on the estimated emotion of the user. For example, the generation unit captures the user's facial expression with a camera and estimates the emotion using an emotion estimation algorithm. For instance, the generation unit calculates an emotion score based on changes in facial expression to estimate the user's emotion. The generation unit can also record the user's voice and estimate the emotion using voice analysis technology. For example, the generation unit analyzes the tone and speed of the voice to calculate an emotion score. Furthermore, the generation unit can collect the user's biometric data (heart rate and skin conductance) with sensors and estimate the emotion using an emotion estimation algorithm. For example, the generation unit calculates an emotion score based on heart rate fluctuations. Thus, the generation unit can estimate the user's emotion and adjust the difficulty level of recipes to be generated based on the estimated emotion. Emotion estimation is realized, for example, by using an emotion engine or generative AI with emotion estimation functions. Generative AI may be a text generation AI (e.g., LLM) or a multimodal generative AI, but is not limited to these examples. Some or all of the above-described processing in the generation unit may be performed using AI or without using AI. For example, the generation unit can input user image data captured by a camera to generative AI and have the generative AI perform emotion estimation. Specifically, the generation unit receives, for user emotion estimation, 224×224 pixel RGB image tensors (e.g., 10 consecutive frames) obtained from a camera, 16 kHz sampled audio waveform data (e.g., 80,000 samples over 5 seconds) obtained from a microphone, and time-series biometric data (e.g., one point per second, total 60 points) from heart rate and skin conductance sensors. Examples of input include “consecutive frames of user's facial images,” “user's speech audio waveform,” and “time-series heart rate data.” The generation unit preprocesses these multimodal data (e.g., image normalization and face region extraction, audio spectrogram conversion, noise removal from biometric data), extracts facial features using convolutional neural networks (CNN), and extracts audio and biometric time-series features using recurrent neural networks (RNN) or Transformer. The extracted feature vectors are integrated in a multimodal fusion layer (e.g., attention mechanism or feature concatenation layer), and emotion labels such as “joy,” “sadness,” “stress,” “relaxation,” and continuous emotion scores (e.g., 0.78) are output by an emotion classification head (e.g., fully connected layer +Softmax). Examples of output include “emotion label: relaxation,” “emotion score: 0.65,” and “estimated confidence: 0.92.” The generation unit uses these emotion estimation results and conditional generation models (e.g., conditional Transformer, Seq2Seq models) to dynamically adjust recipe difficulty parameters (e.g., number of cooking steps, cooking time, number of utensils used, skill level). For example, if the user is stressed, the generation unit preferentially generates “easy, quick, and less error-prone” recipes (e.g., three steps or less, cooking time within 15 minutes), and if the user is relaxed, it generates recipes including “new challenges and elaborate cooking steps” (e.g., five steps or more, use of special utensils). The generation unit continuously adjusts recipe difficulty according to the emotion score and automatically generates recipes optimized for the user's psychological state. AI-based emotion estimation and difficulty adjustment processing, unlike conventional subjective human judgment or simple recipe selection, combines pattern recognition in high-dimensional feature space with rule-based automatic optimization to realize recipe difficulty adjustment optimized for the user's psychological state. The technical effects are that the generation unit, through high-precision emotion estimation and automatic optimization of recipe difficulty by multimodal AI, greatly improves the degree of personalization of user experience, enhances the efficiency, accuracy, and satisfaction of cooking processes, and advances computer technology beyond simple automation. Specific application fields include emotion-adaptive recipe difficulty adjustment for home cooking assistance robots, stress care meal suggestions for health management apps, motivation-linked task generation for educational cooking learning systems, and meal support according to psychological state in nursing facilities.

The generation unit is configured to generate ingredients in consideration of the user's dietary restrictions during generation. For example, if the user is a vegetarian, the generation unit generates ingredients that do not use meat. For instance, the generation unit obtains the user's dietary restriction information from a database and identifies ingredients suitable for vegetarians. The generation unit can also generate ingredients that do not contain gluten if the user desires a gluten-free diet. For example, the generation unit generates a gluten-free ingredient list and provides it to the user. Furthermore, the generation unit can generate appropriate ingredients based on the user's dietary restrictions. For example, the generation unit identifies ingredients based on calorie restrictions or restrictions on specific nutrients. Thus, the generation unit can generate ingredients in consideration of the user's dietary restrictions and provide appropriate dishes. Some or all of the above-described processing in the generation unit may be performed using AI or without using AI. For example, the generation unit can input dietary restriction information obtained from a database to AI to identify appropriate ingredients. Specifically, the generation unit receives user-specific dietary restriction information (e.g., attributes and restriction values such as vegetarian, vegan, gluten-free, low-carb, low-fat, calorie restriction, specific nutrient restriction, and past meal history in a structured table) as input. Examples of input include “dietary restriction: vegetarian,” “gluten-free: True,” and “calorie limit: 500 kcal.” The generation unit preprocesses this dietary restriction information (e.g., normalization of restriction attributes, scaling of nutrient restriction values), matches it with the candidate ingredient list (e.g., all ingredient list output from the recipe analysis unit), and automatically excludes ingredients that violate the restrictions (e.g., meat, gluten-containing ingredients, ingredients high in sugar or fat). Furthermore, the generation unit refers to an alternative ingredient database (e.g., mapping table such as meat substitute→soy meat, wheat flour substitute→rice flour) for the ingredient list after restriction, and automatically proposes alternative ingredients that comply with the restrictions. When using AI, the generation unit utilizes natural language processing models (e.g., large language models, Transformer Encoder) and nutrient estimation models (e.g., regression neural networks) to automatically handle notation variations of ingredient names, decomposition of composite ingredients, and automatic estimation of nutrient values, and generates ingredient lists optimized for the restriction conditions. Examples of input to AI include “ingredient list vector (e.g., pasta, beef, wheat flour, tomato)” and “user dietary restriction vector (e.g., vegetarian, gluten-free),” and AI outputs “compliant ingredient list (e.g., rice flour pasta, tomato),” “alternative proposal list (e.g., beef→soy meat, wheat flour→rice flour),” and “restriction compliance score (e.g., 0.99).” The output results are used for subsequent processing such as branching in ingredient list generation (e.g., automatic exclusion when restrictions are violated, user selection when alternative proposals are made), automatic adjustment of cooking procedures (e.g., switching cooking methods when using substitute ingredients), and notification of restriction compliance to the user. For training the AI model, actual dietary restriction-compliant recipe data and nutrient composition databases are used as teacher data, and loss functions for maximizing compliance rate and satisfaction are employed. Thus, the generation unit, unlike conventional simple ingredient exclusion or manual restriction checking, automates compliant ingredient generation, alternative proposal, and nutrient optimization in high-dimensional feature space using AI, greatly improving the safety, accuracy, and degree of personalization in ingredient generation. The technical effects are that the generation unit, through AI-based dietary restriction information-linked ingredient generation automation, reduces the risk of restriction violations, optimizes for each user, diversifies ingredient proposals, and enhances the reliability of the entire system, thereby improving computer technology itself. Specific application fields include dietary restriction-compliant recipe generation for home cooking assistance robots, restriction-compliant menu management for restaurants, individual restriction meal proposals for health management apps, and individual nutrition restriction meal support in medical and nursing facilities.

The generation unit is configured to customize cooking procedures based on the user's dietary preferences during generation. For example, if the user prefers spicy food, the generation unit generates cooking procedures adjusted for spiciness. For instance, the generation unit obtains the user's preference information from a database and identifies cooking procedures adjusted for spiciness. The generation unit can also generate cooking procedures adjusted for sweetness if the user prefers sweet food. For example, the generation unit generates cooking procedures adjusted for sweetness and provides them to the user. Furthermore, the generation unit can customize cooking procedures based on the user's preferences. For example, the generation unit identifies cooking procedures based on taste preferences and preferred cooking methods. Thus, the generation unit can customize cooking procedures based on the user's dietary preferences and provide appropriate cooking procedures. Some or all of the above-described processing in the generation unit may be performed using AI or without using AI. For example, the generation unit can input preference information obtained from a database to AI to customize cooking procedures. Specifically, the generation unit receives user-specific taste and cooking method preference information (e.g., spiciness level, sweetness level, tolerance for sourness, saltiness, bitterness, preferred cooking methods such as grilling, boiling, steaming, and past evaluation scores and feedback in a structured table) as input. Examples of input include “spiciness level: 3 (out of 5),” “sweetness level: 2,” and “preferred cooking method: grilling.” The generation unit preprocesses this preference information (e.g., normalization of scores, category conversion, aggregation of past history), matches it with the candidate cooking procedure list (e.g., standard procedures output from the recipe analysis unit), and automatically adjusts parameters for seasoning and cooking methods (e.g., amount of spices, amount of sugar, heating time, selection of cooking method). Furthermore, the generation unit automatically generates branching in cooking procedures (e.g., adding chili pepper for emphasis on spiciness, adding sugar for emphasis on sweetness) and addition or omission of steps (e.g., adding grilling step, extending simmering time) according to the user's preferences. When using AI, the generation unit utilizes conditional generation models (e.g., conditional Transformer, Seq2Seq models) and reinforcement learning models to optimize cooking procedures for maximizing user satisfaction. Examples of input to AI include “user preference vector (e.g., spiciness 3,sweetness 2)” and “standard cooking procedure vector,” and AI outputs “customized cooking procedures (e.g., 1. Add chili pepper 2. Sauté longer than usual),” “seasoning parameters (e.g., sugar 5 g→8 g),” and “satisfaction prediction score (e.g., 0.93).” The output results are used for subsequent processing such as branching in cooking procedure generation (e.g., automatic adjustment when reflecting preferences, user selection when proposals are made), automatic adjustment of ingredient lists (e.g., changing amount of spices), and notification of customization to the user. For training the AI model, past user evaluation data and cooking result data are used as teacher data, and loss functions for maximizing satisfaction and minimizing cooking failure rate are employed. Thus, the generation unit, unlike conventional simple procedure selection or manual seasoning adjustment, automates preference reflection, procedure optimization, and seasoning parameter adjustment in high-dimensional feature space using AI, greatly improving the efficiency, accuracy, and degree of personalization in cooking procedure generation. The technical effects are that the generation unit, through AI-based preference information-linked cooking procedure generation automation, improves user satisfaction, optimizes cooking processes, accommodates taste diversity, and strengthens the flexibility of the entire system, thereby improving computer technology itself. Specific application fields include preference-linked cooking procedure generation for home cooking assistance robots, customer preference-responsive menu proposals for restaurants, taste-optimized meal suggestions for health management apps, and individualized instruction support for educational cooking learning systems.

The provision unit is configured to estimate a user's emotion and adjust a format of information to be provided based on the estimated emotion of the user. For example, the provision unit captures the user's facial expression with a camera and estimates the emotion using an emotion estimation algorithm. For instance, the provision unit calculates an emotion score based on changes in facial expression to estimate the user's emotion. The provision unit can also record the user's voice and estimate the emotion using voice analysis technology. For example, the provision unit analyzes the tone and speed of the voice to calculate an emotion score. Furthermore, the provision unit can collect the user's biometric data (heart rate and skin conductance) with sensors and estimate the emotion using an emotion estimation algorithm. For example, the provision unit calculates an emotion score based on heart rate fluctuations. Thus, the provision unit can estimate the user's emotion and adjust a format of information to be provided based on the estimated emotion. Emotion estimation is realized, for example, by using an emotion engine or generative AI with emotion estimation functions. Generative AI may be a text generation AI (e.g., LLM) or a multimodal generative AI, but is not limited to these examples. Some or all of the above-described processing in the provision unit may be performed using AI or without using AI. For example, the provision unit can input user image data captured by a camera to generative AI and have the generative AI perform emotion estimation. Specifically, the provision unit receives, for user emotion estimation, 224×224 pixel RGB image tensors (e.g., 10 consecutive frames) obtained from a camera, 16 kHz sampled audio waveform data (e.g., 80,000 samples over 5 seconds) obtained from a microphone, and time-series biometric data (e.g., one point per second, total 60 points) from heart rate and skin conductance sensors. Examples of input include “consecutive frames of user's facial images,” “user's speech audio waveform,” and “time-series heart rate data.” The provision unit preprocesses these multimodal data (e.g., image normalization and face region extraction, audio spectrogram conversion, noise removal from biometric data), extracts facial features using convolutional neural networks (CNN), and extracts audio and biometric time-series features using recurrent neural networks (RNN) or Transformer. The extracted feature vectors are integrated in a multimodal fusion layer (e.g., attention mechanism or feature concatenation layer), and emotion labels such as “joy,” “sadness,” “stress,” “relaxation,” and continuous emotion scores (e.g., 0.78) are output by an emotion classification head (e.g., fully connected layer+Softmax). Examples of output include “emotion label: relaxation,” “emotion score: 0.65,” and “estimated confidence: 0.92.” The provision unit automatically adjusts information provision formats (e.g., simple display, detailed display, UI parameters such as color scheme, font size, amount of information, notification timing) based on these emotion estimation results. For example, if the user is stressed, the provision unit selects a simple and highly visible display layout, and if the user is relaxed, it displays detailed information and additional explanations. AI-based emotion estimation and information format adjustment processing, unlike conventional subjective human judgment or fixed UI design, combines pattern recognition in high-dimensional feature space with rule-based automatic optimization to realize information presentation optimized for the user's psychological state. The technical effects are that the provision unit, through high-precision emotion estimation and automatic optimization of information formats by multimodal AI, greatly improves the degree of personalization of user experience, enhances the efficiency, accuracy, and satisfaction of information transmission, and advances computer technology beyond simple automation. Specific application fields include emotion-adaptive UI for home cooking assistance robots, stress care information presentation for health management apps, motivation-linked progress display for educational cooking learning systems, and information provision according to psychological state in nursing facilities.

The provision unit is configured to select an optimal provision timing based on the user's schedule during provision. For example, the provision unit refers to the user's schedule and provides information according to the cooking preparation time. For instance, the provision unit links with the user's calendar application and sends notifications according to the cooking preparation time. The provision unit can also select an optimal provision timing based on the user's schedule. For example, the provision unit analyzes the user's schedule and provides information at the optimal timing. Furthermore, the provision unit can adjust the timing of information provision in consideration of the user's schedule. For example, the provision unit adjusts the timing of notifications according to the user's schedule. Thus, the provision unit can select an optimal provision timing based on the user's schedule and provide information at the appropriate timing. Some or all of the above-described processing in the provision unit may be performed using AI or without using AI. For example, the provision unit can input schedule information obtained from a calendar application to AI to select an optimal provision timing. Specifically, the provision unit receives user schedule data (e.g., structured table including start/end times of calendar events, event type, priority, location, planned cooking time, travel time, alarm settings) as input. Examples of input include “event: 18:00-19: 00 cooking,” “event: 19:30-20: 00 meeting,” and “alarm setting: 17:45.” The provision unit preprocesses this schedule data (e.g., standardization of times, category conversion of event types, scoring of priority), analyzes the lead time required for cooking preparation and the user's lifestyle patterns. When using AI, the provision unit utilizes time-series prediction models (e.g., LSTM, Transformer Encoder) and reinforcement learning models, using past notification response history and cooking preparation time data as teacher data, to automatically determine optimal notification timing and information provision timing. Examples of input to AI include “schedule vector (e.g., cooking 18:00-19:00, meeting 19:30-20:00),” “past notification response history (e.g., notification 17:45→response 17:50),” and AI outputs “recommended notification time (e.g., 17:40),” “notification priority (e.g., high),” and “number of reminders (e.g., 2 times).” The output results are used for subsequent processing such as automatic adjustment of notification sending timing, optimization among multiple events, sending reminders to the user, and proposal of splitting cooking preparation steps. For training the AI model, user-specific response patterns and cooking preparation history are used as teacher data, and loss functions for maximizing notification effectiveness and minimizing preparation delay are employed. Thus, the provision unit, unlike conventional simple time reference or manual notification setting, automates schedule optimization and notification timing in high-dimensional feature space using AI, greatly improving the efficiency, accuracy, and degree of personalization in information provision. The technical effects are that the provision unit, through AI-based schedule-linked information provision timing optimization automation, improves user satisfaction, enhances efficiency of cooking preparation, reduces schedule management burden, and increases the flexibility of the entire system, thereby improving computer technology itself. Specific application fields include schedule-linked notification for home cooking assistance robots, reservation-linked cooking start proposals for restaurants, meal timing optimization for health management apps, and assignment submission reminders for educational cooking learning systems.

The provision unit can select an optimal provision method by taking into account the user's device information at the time of provision. For example, when the user is using a smartphone, the provision unit provides information optimized for the screen size. Specifically, the provision unit displays information optimized for the smartphone's screen size. When the user is using a tablet, the provision unit can provide information optimized for the larger screen, such as displaying information tailored to the tablet's screen size. Furthermore, when the user is using a smartwatch, the provision unit can provide concise and highly visible information, such as displaying information optimized for the smartwatch's screen size. Thus, the provision unit can select the optimal provision method by considering the user's device information and provide information in an appropriate manner. Some or all of the above-described processing in the provision unit may be performed using AI or without using AI. For example, the provision unit can acquire device information and select the optimal provision method using AI. Specifically, the provision unit receives as input a structured table of the user's device information (e.g., device type such as smartphone, tablet, smartwatch, PC; screen size such as 5.5 inches, 10.1 inches, 1.5 inches; resolution such as 1080×1920, 2560×1600; OS type; interface constraints such as touch, voice, physical buttons; communication method such as Wi-Fi, Bluetooth, cellular). Example inputs include “Device type: Smartphone”, “Screen size: 6.1 inches”, “Resolution: 2340×1080”, “OS: Android”, etc. The provision unit preprocesses this device information (e.g., categorizing screen size, standardizing resolution, extracting interface attributes) and automatically optimizes the information provision method (e.g., amount of text, image size, layout, notification method, operation method). When using AI, the provision unit utilizes conditional generation models (e.g., conditional Transformer), user interface optimization models, or reinforcement learning models, and uses past user response history and device-specific operation logs as training data to automatically determine the optimal information provision method. Example AI inputs include “device attribute vector (e.g., smartphone, 6.1 inches, touch)”, “past display optimization history”, etc., and the AI outputs “recommended display layout (e.g., single column, large font)”, “notification method (e.g., push notification, vibration)”, “amount of information (e.g., summary display)”, etc. The output results are used for subsequent processing such as automatic switching of information provision methods, optimization of layout, font, and image size, branching of notification methods, and collection of user feedback. For AI model training, user-specific device usage history and display optimization effect data are used as training data, and a loss function aimed at maximizing display efficiency and minimizing error rate is employed. As a result, the provision unit, unlike conventional simple device determination or manual layout adjustment, achieves device optimization and automation of information provision methods in a high-dimensional feature space using AI, greatly improving the efficiency, accuracy, and degree of personalization of information provision. The technical effects include improvement of user satisfaction, prevention of erroneous operations, increased efficiency of information transmission, and enhanced flexibility of the overall system through automation of device-linked information provision method optimization by AI, thereby improving computer technology itself. Specific application fields include multi-device compatible UI for home cooking support robots, tablet ordering systems for restaurants, wearable-linked notifications for health management apps, and device-optimized displays for educational cooking learning systems.

The provision unit can estimate the user's emotion and determine the priority of information to be provided based on the estimated emotion. For example, the provision unit captures the user's facial expression with a camera and estimates the emotion using an emotion estimation algorithm. The provision unit calculates an emotion score based on changes in facial expression to estimate the user's emotion. Additionally, the provision unit can record the user's voice and estimate the emotion using voice analysis technology, such as analyzing the tone and speed of the voice to calculate an emotion score. Furthermore, the provision unit can collect the user's biometric data (heart rate and skin conductance) with sensors and estimate the emotion using an emotion estimation algorithm, such as calculating an emotion score based on heart rate variability. Thus, the provision unit can estimate the user's emotion and determine the priority of information to be provided based on the estimated emotion. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processing in the provision unit may be performed using AI or without using AI. For example, the provision unit can input user image data captured by a camera into generative AI and have the generative AI perform emotion estimation. Specifically, the provision unit receives as input a 224×224 pixel RGB image tensor (e.g., 10 consecutive frames) obtained from a camera, 16 kHz sampled audio waveform data (e.g., 80,000 samples over 5 seconds) obtained from a microphone, and time-series biometric data (e.g., one point per second, total 60 points) from heart rate and skin conductance sensors for emotion estimation. Example inputs include “user facial image consecutive frames”, “user speech audio waveform”, “heart rate time-series data”, etc. The provision unit preprocesses these multimodal data (e.g., image normalization and face region extraction, conversion of audio to spectrogram, noise removal from biometric data), extracts facial features using a convolutional neural network (CNN), and extracts audio and biometric time-series features using a recurrent neural network (RNN) or Transformer. The extracted feature vectors are integrated in a multimodal fusion layer (e.g., attention mechanism or feature concatenation layer), and an emotion classification head (e.g., fully connected layer+Softmax) outputs emotion labels such as “joy”, “sadness”, “stress”, “relaxation”, and continuous emotion scores (e.g., 0.78). Example outputs include “emotion label: stress”, “emotion score: 0.65”, “estimated confidence: 0.92”, etc. Based on these emotion estimation results, the provision unit calculates priority scores for an information provision candidate list (e.g., cooking progress, nutritional information, origin of the dish, precautions, etc.) and presents information in order of suitability for the user's psychological state. For example, in a stress state, “concise progress information” or “reassuring messages” are prioritized, while in a relaxed state, “detailed nutritional explanations” or “historical background of the dish” are displayed at the top. AI-based priority determination processing, unlike conventional subjective human judgment or fixed information presentation order, combines pattern recognition in high-dimensional feature space with rule-based automatic optimization to realize information presentation optimized for the user's psychological state. The technical effects include greatly improving the degree of personalization of the user experience, enhancing the efficiency, accuracy, and satisfaction of information transmission, and advancing computer technology beyond simple automation through high-precision emotion estimation and automatic optimization of information priority by multimodal AI. Specific application fields include emotion-adaptive information presentation for home cooking support robots, prioritized stress care information display for health management apps, motivation-linked explanation presentation for educational cooking learning systems, and provision of cautionary information according to psychological state in nursing care facilities.

The provision unit can customize the content to be provided by referring to the user's past feedback at the time of provision. For example, the provision unit provides information that matches the user's preferences based on past feedback. The provision unit acquires the user's past feedback from a database and identifies information that matches the user's preferences. Additionally, the provision unit can provide information reflecting improvements based on the user's past feedback, such as analyzing the user's feedback and identifying information that incorporates improvements. Furthermore, the provision unit can customize the content to be provided by referring to the user's past feedback, such as providing customized information based on the user's feedback. Thus, the provision unit can customize the content to be provided by referring to the user's past feedback and provide appropriate information. Some or all of the above-described processing in the provision unit may be performed using AI or without using AI. For example, the provision unit can input feedback information acquired from a database into AI and customize the content to be provided. Specifically, the provision unit receives as input a user-specific feedback database (e.g., a structured table including evaluation scores for past cooking results, comments, requests for improvement, satisfaction surveys, operation history, etc.). Example inputs include “evaluation score: 4.5”, “comment: I want it to be spicier”, “request for improvement: please simplify the procedure”, etc. The provision unit preprocesses this feedback data (e.g., tokenization of text, normalization of scores, category classification, time-series aggregation), and generates user preference and improvement request vectors through feature extraction layers (e.g., embedding layer, text feature extraction layer). When using AI, the provision unit utilizes natural language processing models (e.g., large language models, Transformer Encoder) and recommendation algorithms to extract important keywords and improvement points from feedback content and automatically optimize the content, expression, order, and level of detail of the information to be provided. Example AI inputs include “feedback vector (e.g., request for spiciness, request for simplified procedure)”, “past display history”, etc., and the AI outputs “customized information list (e.g., addition of explanation for spiciness adjustment, summary display of procedure)”, “satisfaction prediction score (e.g., 0.93)”, etc. The output results are used for subsequent processing such as automatic switching of information provision content, customized display for each user, and branching to reflect improvements. For AI model training, past user response data and satisfaction data are used as training data, and a loss function aimed at maximizing satisfaction and reflecting improvement requests is employed. As a result, the provision unit, unlike conventional simple history reference or manual customization, achieves feedback analysis, content optimization, and personalization automation in a high-dimensional feature space using AI, greatly improving the efficiency, accuracy, and satisfaction of information provision. The technical effects include improvement of user satisfaction, rapid reflection of improvement requests, increased efficiency of information transmission, and enhanced flexibility of the overall system through automation of feedback-linked information provision content optimization by AI, thereby improving computer technology itself. Specific application fields include feedback-reflective UI for home cooking support robots, customer request-linked menu explanations for restaurants, individualized improvement proposals for health management apps, and individualized instruction optimization for educational cooking learning systems.

The provision unit can adjust the content to be provided by considering the user's geographic location information at the time of provision. For example, the provision unit provides region-specific information based on the user's geographic location information. The provision unit acquires the user's location information and provides information related to that region. Additionally, the provision unit can provide optimal information based on the user's geographic location information, such as analyzing the user's location information and identifying optimal information. Furthermore, the provision unit can adjust the content to be provided by considering the user's geographic location information, such as providing information on region-specific ingredients or dishes based on the user's location information. Thus, the provision unit can adjust the content to be provided by considering the user's geographic location information and provide appropriate information. Some or all of the above-described processing in the provision unit may be performed using AI or without using AI. For example, the provision unit can acquire location information and use AI to identify optimal information. Specifically, the provision unit receives as input the user's geographic location information (e.g., latitude and longitude, prefecture, city/ward/town/village, GPS coordinates, region code, etc. in a structured table). Example inputs include “location information: Shinjuku-ku, Tokyo”, “GPS coordinates: 35.6895,139.6917”, “region code: JP-13”, etc. The provision unit preprocesses this location information (e.g., reverse geocoding from coordinates to region name, extraction of regional attributes, addition of seasonal and climate information), and cross-references it with region-specific ingredient databases, local cuisine databases, and regional event calendars to generate a list of information candidates optimized for regional characteristics. When using AI, the provision unit utilizes natural language processing models (e.g., large language models, Transformer Encoder) and recommendation algorithms to combine regional information with user attributes, preferences, season, and event information, and automatically select optimal information (e.g., region-limited recipes, explanations of seasonal ingredients, event-linked menus, explanations of dishes for tourists). Example AI inputs include “location information vector (e.g., Shinjuku-ku, Tokyo)”, “season/event attributes”, etc., and the AI outputs “region-specific information list (e.g., local cuisine of Shinjuku-ku, seasonal vegetables)”, “priority display score (e.g., 0.92)”, etc. The output results are used for subsequent processing such as automatic switching of information provision content, region-linked explanation display, guidance for tourists, and event-linked notifications. For AI model training, regional cuisine data and user response data for each region are used as training data, and a loss function aimed at maximizing regional suitability and satisfaction is employed. As a result, the provision unit, unlike conventional simple location reference or manual selection of regional information, achieves regional optimization and automation of information content in a high-dimensional feature space using AI, greatly improving the efficiency, accuracy, and degree of personalization of information provision. The technical effects include improvement of user satisfaction, enhanced responsiveness to regional and seasonal characteristics, support for tourism and regional promotion, and increased flexibility of the overall system through automation of geographic location-linked information provision content optimization by AI, thereby improving computer technology itself. Specific application fields include region-linked recipe explanations for home cooking support robots, region-limited menu proposals for restaurants, regional ingredient proposals for health management apps, and introductions of regional cuisine at tourist destinations.

The cooking unit can estimate the user's emotion and adjust the cooking progress speed based on the estimated emotion. For example, the cooking unit captures the user's facial expression with a camera and estimates the emotion using an emotion estimation algorithm. The cooking unit calculates an emotion score based on changes in facial expression to estimate the user's emotion. Additionally, the cooking unit can record the user's voice and estimate the emotion using voice analysis technology, such as analyzing the tone and speed of the voice to calculate an emotion score. Furthermore, the cooking unit can collect the user's biometric data (heart rate and skin conductance) with sensors and estimate the emotion using an emotion estimation algorithm, such as calculating an emotion score based on heart rate variability. Thus, the cooking unit can estimate the user's emotion and adjust the cooking progress speed based on the estimated emotion. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processing in the cooking unit may be performed using AI or without using AI. For example, the cooking unit can input user image data captured by a camera into generative AI and have the generative AI perform emotion estimation. Specifically, the cooking unit receives as input a 224×224 pixel RGB image tensor (e.g., 10 consecutive frames) obtained from a camera, 16 kHz sampled audio waveform data (e.g., 80,000 samples over 5 seconds) obtained from a microphone, and time-series biometric data (e.g., one point per second, total 60 points) from heart rate and skin conductance sensors for emotion estimation. Example inputs include “user facial image consecutive frames”, “user speech audio waveform”, “heart rate time-series data”, etc. The cooking unit preprocesses these multimodal data (e.g., image normalization and face region extraction, conversion of audio to spectrogram, noise removal from biometric data), extracts facial features using a convolutional neural network, and extracts audio and biometric time-series features using a recurrent neural network or Transformer. The cooking unit integrates the extracted feature vectors in a multimodal fusion layer (attention mechanism or feature concatenation layer), and outputs emotion labels such as “joy”, “sadness”, “stress”, “relaxation”, and continuous emotion scores (e.g., 0.78) through an emotion classification head (fully connected layer+Softmax). Example outputs include “emotion label: stress”, “emotion score: 0.65”, “estimated confidence: 0.92”, etc. Based on these emotion estimation results, the cooking unit inputs them into a cooking progress speed control module and dynamically adjusts the timing and speed parameters of each process such as heating, stirring, and plating using a conditional control algorithm (e.g., PID control+rule-based branching). For example, when the user is in a stress state, the cooking unit automatically applies “shortened intervals between processes”, “increased heating speed”, “increased notification frequency”, etc., and when the user is in a relaxed state, it applies “extended intervals between processes”, “detailed explanation display”, “decreased progress speed”, etc. AI-based emotion estimation and progress speed adjustment processing, unlike conventional subjective human judgment or fixed timer control, combines pattern recognition in high-dimensional feature space with rule-based automatic optimization to realize cooking progress control optimized for the user's psychological state. The technical effects include greatly improving the degree of personalization of the user experience, enhancing the efficiency, accuracy, and satisfaction of cooking processes, and advancing computer technology beyond simple automation through high-precision emotion estimation and automatic optimization of progress speed by multimodal AI. Specific application fields include emotion-adaptive progress control for home cooking support robots, stress care cooking support for health management apps, motivation-linked progress adjustment for educational cooking learning systems, and cooking support according to psychological state in nursing care facilities.

The cooking unit can monitor temperature and humidity in real time during cooking and maintain an optimal cooking environment. For example, the cooking unit monitors the temperature in real time during cooking and maintains the optimal temperature, such as using a temperature sensor to monitor the temperature and adjusting it as necessary. Additionally, the cooking unit can monitor humidity in real time during cooking and maintain the optimal humidity, such as using a humidity sensor to monitor humidity and adjusting it as necessary. Furthermore, the cooking unit can adjust the cooking environment according to changes in temperature and humidity, such as making adjustments based on temperature and humidity data to maintain the optimal cooking environment. Thus, the cooking unit can monitor temperature and humidity in real time during cooking and maintain an optimal cooking environment. Some or all of the above-described processing in the cooking unit may be performed using AI or without using AI. For example, the cooking unit can input data acquired from temperature and humidity sensors into AI and make adjustments to maintain the optimal cooking environment. Specifically, the cooking unit receives as input temperature and humidity data (e.g., temperature 23.5° C., humidity 55%) obtained every second from multiple temperature sensors (e.g., thermistor, infrared sensor) and humidity sensors (e.g., capacitive, resistive type) as a time-series tensor (e.g., 60 seconds×2 types). Example inputs include “temperature time series: 23.5, 23.6, 23.7 . . . ”, “humidity time series: 55, 56, 54 . . . ”, etc. The cooking unit preprocesses these sensor data (e.g., outlier removal, moving average smoothing, standardization), and inputs them into anomaly detection algorithms (e.g., autoencoder, LSTM-based prediction model) and control optimization models (e.g., reinforcement learning model, rule-based PID control). When using AI, the cooking unit outputs “optimal cooking environment score (e.g., 0.95)”, “anomaly detection flag (e.g., True)”, “recommended control action (e.g., heating ON, humidification OFF)”, etc. Example outputs include “temperature adjustment: heating ON”, “humidity adjustment: humidification OFF”, “anomaly detection: none”, etc. Based on these outputs, the cooking unit automatically generates control signals for heaters, humidifiers, ventilation fans, etc., and optimizes the cooking environment in real time. For AI model training, past cooking logs and optimal environment data are used as training data, and a loss function aimed at maximizing cooking quality and optimizing energy efficiency is employed. As a result, the cooking unit, unlike conventional simple threshold control or manual environment adjustment, achieves environment optimization, anomaly detection, and control automation in a high-dimensional feature space using AI, greatly improving cooking quality, safety, and energy efficiency. The technical effects include stabilization of cooking quality, reduction of failure rate, reduction of energy consumption, and improvement of overall system reliability through automation of real-time environment optimization by AI, thereby improving computer technology itself. Specific application fields include environment control for home cooking support robots, quality management for commercial automatic cooking lines, cooking environment recording for health management apps, and adaptation to environmental changes for educational cooking learning systems.

The cooking unit can monitor the state of cooking utensils during cooking and perform maintenance as needed. For example, the cooking unit monitors the temperature and operating state of cooking utensils and performs maintenance when an abnormality occurs, such as using temperature sensors and operation sensors to monitor the state of cooking utensils and executing maintenance when an abnormality is detected. Additionally, the cooking unit can monitor the usage frequency of cooking utensils and propose regular maintenance, such as determining the timing for regular maintenance based on usage frequency data. Furthermore, the cooking unit can monitor the deterioration state of cooking utensils and notify the user when replacement is necessary, such as using deterioration sensors to monitor the state of cooking utensils and notifying the user when replacement is required. Thus, the cooking unit can monitor the state of cooking utensils and perform maintenance as needed. Some or all of the above-described processing in the cooking unit may be performed using AI or without using AI. For example, the cooking unit can input data acquired from sensors into AI to monitor the state of cooking utensils and perform maintenance. Specifically, the cooking unit receives as input state data (e.g., temperature 120° C., vibration value 0.02G, energization time 1000 hours, resistance change 0.5%) obtained every minute from temperature sensors (e.g., thermistor), operation sensors (e.g., accelerometer, current sensor), and deterioration sensors (e.g., resistance change type, wear detection type) for each cooking utensil as a structured vector. Example inputs include “temperature: 120° C.”, “vibration: 0.02 G”, “energization time: 1000 h”, “resistance change: 0.5%”, etc. The cooking unit preprocesses these sensor data (e.g., noise removal, correction of abnormal values, time-series aggregation), and inputs them into anomaly detection models (e.g., autoencoder, LSTM-based prediction model), deterioration prediction models (e.g., regression neural network), and maintenance recommendation models (e.g., rule-based, reinforcement learning model). When using AI, the cooking unit outputs “anomaly detection flag (e.g., True)”, “deterioration score (e.g., 0.85)”, “recommended maintenance timing (e.g., 50 hours remaining)”, etc. Example outputs include “anomaly detection: present”, “deterioration: high”, “replacement recommendation: True”, etc. Based on these outputs, the cooking unit executes subsequent processing such as maintenance notifications to the user, automatic stopping of cooking utensils, and recording of maintenance history. For AI model training, past failure history and maintenance records are used as training data, and a loss function aimed at maximizing failure prediction accuracy and minimizing downtime is employed. As a result, the cooking unit, unlike conventional simple periodic inspections or manual abnormality monitoring, achieves automation of anomaly detection, deterioration prediction, and maintenance optimization in a high-dimensional feature space using AI, greatly improving the reliability, safety, and operational efficiency of cooking utensils. The technical effects include reduction of failure risk, reduction of maintenance costs, and improvement of overall system operating rate through automation of state monitoring and maintenance optimization by AI, thereby improving computer technology itself. Specific application fields include automatic maintenance for home cooking support robots, predictive maintenance for commercial automatic cooking lines, cooking utensil management for health management apps, and utensil state monitoring for educational cooking learning systems.

The cooking unit can estimate the user's emotion and notify the cooking progress status based on the estimated emotion. For example, the cooking unit captures the user's facial expression with a camera and estimates the emotion using an emotion estimation algorithm. The cooking unit calculates an emotion score based on changes in facial expression to estimate the user's emotion. Additionally, the cooking unit can record the user's voice and estimate the emotion using voice analysis technology, such as analyzing the tone and speed of the voice to calculate an emotion score. Furthermore, the cooking unit can collect the user's biometric data (heart rate and skin conductance) with sensors and estimate the emotion using an emotion estimation algorithm, such as calculating an emotion score based on heart rate variability. Thus, the cooking unit can estimate the user's emotion and notify the cooking progress status based on the estimated emotion. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processing in the cooking unit may be performed using AI or without using AI. For example, the cooking unit can input user image data captured by a camera into generative AI and have the generative AI perform emotion estimation. Specifically, the cooking unit receives as input a 224×224 pixel RGB image tensor (e.g., 10 consecutive frames) obtained from a camera, 16 kHz sampled audio waveform data (e.g., 80,000 samples over 5 seconds) obtained from a microphone, and time-series biometric data (e.g., one point per second, total 60 points) from heart rate and skin conductance sensors for emotion estimation. Example inputs include “user facial image consecutive frames”, “user speech audio waveform”, “heart rate time-series data”, etc. The cooking unit preprocesses these multimodal data (e.g., image normalization and face region extraction, conversion of audio to spectrogram, noise removal from biometric data), extracts facial features using a convolutional neural network, and extracts audio and biometric time-series features using a recurrent neural network or Transformer. The cooking unit integrates the extracted feature vectors in a multimodal fusion layer and outputs emotion labels and emotion scores through an emotion classification head. Example outputs include “emotion label: relaxation”, “emotion score: 0.65”, “estimated confidence: 0.92”, etc. Based on these emotion estimation results, the cooking unit inputs them into a progress notification control module and automatically adjusts notification content (e.g., progress bar, voice notification, push notification), notification timing, and notification detail level (e.g., simple, detailed). For example, when the user is in a stress state, the cooking unit applies “concise progress notifications”, “reassuring messages”, “increased notification frequency”, etc., and when the user is in a relaxed state, it applies “detailed progress explanations”, “additional information display”, etc. AI-based emotion estimation and progress notification adjustment processing, unlike conventional subjective human judgment or fixed notification design, combines pattern recognition in high-dimensional feature space with rule-based automatic optimization to realize progress notifications optimized for the user's psychological state. The technical effects include greatly improving the degree of personalization of the user experience, enhancing the efficiency, accuracy, and satisfaction of information transmission, and advancing computer technology beyond simple automation through high-precision emotion estimation and automatic optimization of progress notifications by multimodal AI. Specific application fields include emotion-adaptive progress notifications for home cooking support robots, stress care progress presentation for health management apps, motivation-linked progress notifications for educational cooking learning systems, and progress guidance according to psychological state in nursing care facilities.

The cooking unit can customize the finished state of cooking according to the user's preferences during cooking. For example, when the user prefers spicy food, the cooking unit provides a finished state with adjusted spiciness. The cooking unit acquires the user's preference information from a database and identifies a finished state with adjusted spiciness. Additionally, when the user prefers sweet food, the cooking unit can provide a finished state with adjusted sweetness, such as providing a finished state with adjusted sweetness to the user. Furthermore, the cooking unit can customize the finished state of cooking based on the user's preferences, such as identifying the finished state based on taste preferences or preferred cooking methods. Thus, the cooking unit can customize the finished state of cooking according to the user's preferences and provide appropriate dishes. Some or all of the above-described processing in the cooking unit may be performed using AI or without using AI. For example, the cooking unit can input preference information acquired from a database into AI and customize the finished state of cooking.

The cooking unit can monitor aroma and sound during cooking and perform adjustments to obtain optimal cooking results. For example, the cooking unit monitors aroma during cooking and makes adjustments to ensure the aroma is in an optimal state, such as using an aroma sensor to monitor aroma and making adjustments as necessary. Additionally, the cooking unit can monitor sound during cooking and make adjustments to ensure the sound is in an optimal state, such as using a sound sensor to monitor sound and making adjustments as necessary. Furthermore, the cooking unit can adjust the cooking method according to changes in aroma and sound, such as making adjustments based on aroma and sound data to obtain optimal cooking results. Thus, the cooking unit can monitor aroma and sound during cooking and perform adjustments to obtain optimal cooking results. Some or all of the above-described processing in the cooking unit may be performed using AI or without using AI. For example, the cooking unit can input data acquired from aroma and sound sensors into AI and make adjustments to obtain optimal cooking results.

The collection unit can estimate the user's emotion and determine the priority of recipes or cooking videos to be collected based on the estimated emotion of the user. For example, the collection unit captures the user's facial expression with a camera and estimates the emotion using an emotion estimation algorithm. The collection unit calculates an emotion score based on changes in facial expression to estimate the user's emotion. Additionally, the collection unit can record the user's voice and estimate the emotion using voice analysis technology, such as analyzing the tone and speed of the voice to calculate an emotion score. Furthermore, the collection unit can collect the user's biometric data (heart rate and skin conductance) with sensors and estimate the emotion using an emotion estimation algorithm, such as calculating an emotion score based on heart rate variability. Thus, the collection unit can estimate the user's emotion and determine the priority of recipes or cooking videos to be collected based on the estimated emotion of the user. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processing in the collection unit may be performed using AI or without using AI. For example, the collection unit can input user image data captured by a camera into generative AI and have the generative AI perform emotion estimation.

The collection unit can preferentially collect recipes that match the user's preferences by referring to the user's past cooking history at the time of collection. For example, the collection unit preferentially collects recipes that match the user's preferences based on dishes the user has cooked in the past. The collection unit acquires the user's past cooking history from a database and identifies recipes that match the user's preferences. Additionally, the collection unit can preferentially collect recipes for dishes that the user frequently cooks based on the user's past cooking history, such as analyzing the user's cooking history and identifying recipes for frequently cooked dishes. Furthermore, the collection unit can analyze the user's past cooking history and propose new dishes, such as proposing new recipes based on the user's preferences. Thus, the collection unit can preferentially collect recipes that match the user's preferences by referring to the user's past cooking history. Some or all of the above-described processing in the collection unit may be performed using AI or without using AI. For example, the collection unit can input cooking history acquired from a database into AI and identify recipes that match the user's preferences.

The collection unit can adjust categories of recipes to be collected based on the estimated emotion of the user. For example, the collection unit captures the user's facial expression with a camera and estimates the emotion using an emotion estimation algorithm. The collection unit calculates an emotion score based on changes in facial expression to estimate the user's emotion. Additionally, the collection unit can record the user's voice and estimate the emotion using voice analysis technology, such as analyzing the tone and speed of the voice to calculate an emotion score. Furthermore, the collection unit can collect the user's biometric data (heart rate and skin conductance) with sensors and estimate the emotion using an emotion estimation algorithm, such as calculating an emotion score based on heart rate variability. Thus, the collection unit can estimate the user's emotion and adjust categories of recipes to be collected based on the estimated emotion of the user. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processing in the collection unit may be performed using AI or without using AI. For example, the collection unit can input user image data captured by a camera into generative AI and have the generative AI perform emotion estimation.

The collection unit can preferentially collect highly relevant recipes by considering the user's geographic location information at the time of collection. For example, the collection unit preferentially collects region-specific recipes based on the user's geographic location information. The collection unit acquires the user's location information and collects recipes related to that region. Additionally, the collection unit can collect optimal recipes based on the user's geographic location information, such as analyzing the user's location information and identifying optimal recipes. Furthermore, the collection unit can preferentially collect highly relevant recipes by considering the user's geographic location information, such as collecting recipes for region-specific ingredients or dishes based on the user's location information. Thus, the collection unit can preferentially collect highly relevant recipes by considering the user's geographic location information and provide appropriate information. Some or all of the above-described processing in the collection unit may be performed using AI or without using AI. For example, the collection unit can acquire location information and use AI to identify optimal recipes.

The storage unit can estimate the user's emotion and determine the priority of ingredients and cooking procedures to be stored based on the estimated emotion of the user. For example, the storage unit captures the user's facial expression with a camera and estimates the emotion using an emotion estimation algorithm. The storage unit calculates an emotion score based on changes in facial expression to estimate the user's emotion. Additionally, the storage unit can record the user's voice and estimate the emotion using voice analysis technology, such as analyzing the tone and speed of the voice to calculate an emotion score. Furthermore, the storage unit can collect the user's biometric data (heart rate and skin conductance) with sensors and estimate the emotion using an emotion estimation algorithm, such as calculating an emotion score based on heart rate variability. Thus, the storage unit can estimate the user's emotion and determine the priority of ingredients and cooking procedures to be stored based on the estimated emotion of the user. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processing in the storage unit may be performed using AI or without using AI. For example, the storage unit can input user image data captured by a camera into generative AI and have the generative AI perform emotion estimation.

The storage unit can preferentially store ingredients and cooking procedures that match the user's preferences by referring to the user's past cooking history at the time of storage. For example, the storage unit preferentially stores ingredients and cooking procedures that match the user's preferences based on dishes the user has cooked in the past. The storage unit acquires the user's past cooking history from a database and identifies ingredients and cooking procedures that match the user's preferences. Additionally, the storage unit can preferentially store ingredients and cooking procedures for dishes that the user frequently cooks based on the user's past cooking history, such as analyzing the user's cooking history and identifying ingredients and cooking procedures for frequently cooked dishes. Furthermore, the storage unit can analyze the user's past cooking history and propose new ingredients and cooking procedures, such as proposing new ingredients and cooking procedures based on the user's preferences. Thus, the storage unit can preferentially store ingredients and cooking procedures that match the user's preferences by referring to the user's past cooking history. Some or all of the above-described processing in the storage unit may be performed using AI or without using AI. For example, the storage unit can input cooking history acquired from a database into AI and identify ingredients and cooking procedures that match the user's preferences.

The storage unit can adjust a format of information to be stored based on the estimated emotion of the user. For example, the storage unit captures the user's facial expression with a camera and estimates the emotion using an emotion estimation algorithm. The storage unit calculates an emotion score based on changes in facial expression to estimate the user's emotion. Additionally, the storage unit can record the user's voice and estimate the emotion using voice analysis technology, such as analyzing the tone and speed of the voice to calculate an emotion score. Furthermore, the storage unit can collect the user's biometric data (heart rate and skin conductance) with sensors and estimate the emotion using an emotion estimation algorithm, such as calculating an emotion score based on heart rate variability. Thus, the storage unit can estimate the user's emotion and adjust a format of information to be stored based on the estimated emotion of the user. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processing in the storage unit may be performed using AI or without using AI. For example, the storage unit can input user image data captured by a camera into generative AI and have the generative AI perform emotion estimation.

The storage unit can select an optimal storage method by considering the user's device information at the time of storage. For example, when the user is using a smartphone, the storage unit stores information optimized for the screen size, such as storing information optimized for the smartphone's screen size. When the user is using a tablet, the storage unit can store information optimized for the larger screen, such as storing information tailored to the tablet's screen size. Furthermore, when the user is using a smartwatch, the storage unit can store concise and highly visible information, such as storing information optimized for the smartwatch's screen size. Thus, the storage unit can select the optimal storage method by considering the user's device information and store appropriate information. Some or all of the above-described processing in the storage unit may be performed using AI or without using AI. For example, the storage unit can acquire device information and select the optimal storage method using AI.

The output unit can estimate the user's emotion and adjust a display method of cooking results to be output based on the estimated emotion of the user. For example, the output unit captures the user's facial expression with a camera and estimates the emotion using an emotion estimation algorithm. The output unit calculates an emotion score based on changes in facial expression to estimate the user's emotion. Additionally, the output unit can record the user's voice and estimate the emotion using voice analysis technology, such as analyzing the tone and speed of the voice to calculate an emotion score. Furthermore, the output unit can collect the user's biometric data (heart rate and skin conductance) with sensors and estimate the emotion using an emotion estimation algorithm, such as calculating an emotion score based on heart rate variability. Thus, the output unit can estimate the user's emotion and adjust a display method of cooking results to be output based on the estimated emotion of the user. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processing in the output unit may be performed using AI or without using AI. For example, the output unit can input user image data captured by a camera into generative AI and have the generative AI perform emotion estimation.

The output unit can select an optimal display method by referring to the user's past feedback at the time of output. For example, the output unit provides a display method that matches the user's preferences based on past feedback. The output unit acquires the user's past feedback from a database and identifies a display method that matches the user's preferences. Additionally, the output unit can provide a display method reflecting improvements based on the user's past feedback, such as analyzing the user's feedback and identifying a display method that incorporates improvements. Furthermore, the output unit can customize the display method by referring to the user's past feedback, such as providing a customized display method based on the user's feedback. Thus, the output unit can select an optimal display method by referring to the user's past feedback and provide appropriate information. Some or all of the above-described processing in the output unit may be performed using AI or without using AI. For example, the output unit can input feedback information acquired from a database into AI and select an optimal display method.

The output unit can estimate a user's emotion and determine the priority of information to be output based on the estimated emotion of the user. For example, the output unit may capture the user's facial expression with a camera and estimate the emotion using an emotion estimation algorithm. For example, the output unit may calculate an emotion score based on changes in facial expression and estimate the user's emotion. Additionally, the output unit may record the user's voice and estimate the emotion using voice analysis technology. For example, the output unit may analyze the tone and speed of the voice and calculate an emotion score. Furthermore, the output unit may collect the user's biometric data (such as heart rate or skin electrical activity) with sensors and estimate the emotion using an emotion estimation algorithm. For example, the output unit may calculate an emotion score based on heart rate variability. In this way, the output unit can estimate the user's emotion and determine the priority of information to be output based on the estimated emotion. Emotion estimation may be implemented, for example, using an emotion engine or generative AI with emotion estimation functions. The generative AI may be a text generation AI (such as an LLM) or a multimodal generative AI, but is not limited to these examples. Some or all of the above-described processing in the output unit may be performed using AI or without using AI. For example, the output unit may input image data of the user captured by a camera into generative AI and have the generative AI perform emotion estimation for the user.

The output unit can select an optimal display method at the time of output by considering the user's device information. For example, if the user is using a smartphone, the output unit provides a display method optimized for the screen size. For example, the output unit displays information optimized for the smartphone's screen size. If the user is using a tablet, the output unit can also provide a display method optimized for the larger screen. For example, the output unit displays information according to the tablet's screen size. Furthermore, if the user is using a smartwatch, the output unit can provide a concise and highly visible display method. For example, the output unit displays information optimized for the smartwatch's screen size. In this way, the output unit can select an optimal display method by considering the user's device information and provide appropriate information. Some or all of the above-described processing in the output unit may be performed using AI or without using AI. For example, the output unit may acquire device information and select an optimal display method using AI.

The system according to the embodiment is not limited to the examples described above, and various modifications are possible, for example, as follows.

The analysis unit can also analyze recipes or cooking videos by considering the user's dietary restrictions and allergy information. For example, the analysis unit excludes recipes containing ingredients to which the user is allergic and proposes alternative ingredients. Additionally, the analysis unit can select appropriate recipes based on the user's dietary restrictions. For example, for users with vegetarian or gluten-free dietary restrictions, appropriate recipes are provided. Furthermore, the analysis unit can propose recipes with balanced nutrition based on the user's health condition. For example, for users on a diet, low-calorie recipes are provided.

The collection unit can also collect recipes or cooking videos by considering the user's ingredient inventory information. For example, the collection unit refers to the user's refrigerator inventory information and preferentially collects recipes that use ingredients in stock. Additionally, the collection unit can exclude recipes containing ingredients that are in short supply and propose recipes using alternative ingredients. Furthermore, the collection unit can propose waste-free cooking based on the user's inventory information. For example, the collection unit generates a necessary ingredient list based on inventory information and proposes waste-free cooking.

The storage unit can also store ingredients and cooking procedures by considering the user's dietary restrictions and allergy information. For example, the storage unit stores an ingredient list that does not include ingredients to which the user is allergic and allows later reference. Additionally, the storage unit can store appropriate ingredients and cooking procedures based on the user's dietary restrictions. For example, for users with vegetarian or gluten-free dietary restrictions, appropriate ingredients and cooking procedures are stored. Furthermore, the storage unit can store ingredients and cooking procedures with balanced nutrition based on the user's health condition. For example, for users on a diet, low-calorie ingredients and cooking procedures are stored.

The output unit can also provide cooking results by considering the user's dietary restrictions and allergy information. For example, the output unit provides cooking results that do not include ingredients to which the user is allergic and provides them visually to the user. Additionally, the output unit can provide appropriate cooking results based on the user's dietary restrictions. For example, for users with vegetarian or gluten-free dietary restrictions, appropriate cooking results are provided. Furthermore, the output unit can provide cooking results with balanced nutrition based on the user's health condition. For example, for users on a diet, low-calorie cooking results are provided.

The analysis unit can estimate a user's emotion and adjust the difficulty level of recipes or cooking videos based on the estimated emotion. For example, if the user is feeling stressed, the analysis unit preferentially analyzes simple recipes. If the user is relaxed, the analysis unit can propose challenging recipes. Furthermore, the analysis unit can adjust the number of steps or cooking time of recipes based on the user's emotion. For example, if the user is busy, recipes that can be prepared in a short time are proposed.

The generation unit can estimate a user's emotion and adjust the ingredients and cooking procedures to be generated based on the estimated emotion. For example, if the user is tired, the generation unit generates simple ingredients and procedures. If the user is energetic, the generation unit can generate complex ingredients and procedures. Furthermore, the generation unit can adjust the types and amounts of ingredients based on the user's emotion. For example, if the user is on a diet and feeling stressed, the generation unit generates low-calorie ingredients.

The provision unit can estimate a user's emotion and adjust the format of information to be provided based on the estimated emotion. For example, if the user is tired, the provision unit provides concise and highly visible information. If the user is relaxed, the provision unit can provide detailed information. Furthermore, the provision unit can adjust the display method of information based on the user's emotion. For example, if the user is feeling stressed, the provision unit displays information with calm colors.

The cooking unit can estimate a user's emotion and adjust the cooking progress speed based on the estimated emotion. For example, if the user is in a hurry, the cooking unit speeds up the cooking progress. If the user is relaxed, the cooking unit can slow down the cooking progress. Furthermore, the cooking unit can adjust the cooking steps based on the user's emotion. For example, if the user is feeling stressed, the cooking unit divides the cooking into simple steps.

The collection unit can estimate a user's emotion and determine the priority of recipes or cooking videos to be collected based on the estimated emotion. For example, if the user is feeling stressed, the collection unit preferentially collects recipes with a relaxing effect. If the user is energetic, the collection unit can collect recipes suitable for energy replenishment. Furthermore, the collection unit can adjust the categories of recipes to be collected based on the user's emotion. For example, if the user is tired, the collection unit collects recipes that can be easily prepared.

The storage unit can estimate a user's emotion and determine the priority of ingredients and cooking procedures to be stored based on the estimated emotion. For example, if the user is feeling stressed, the storage unit preferentially stores ingredients and cooking procedures with a relaxing effect. If the user is energetic, the storage unit can store ingredients and cooking procedures suitable for energy replenishment. Furthermore, the storage unit can adjust the format of information to be stored based on the user's emotion. For example, if the user is tired, the storage unit stores information in a concise format.

The following is a brief description of the processing flow of Example of the Embodiment.
Step 1: The analysis unit analyzes a recipe or a cooking video. The analysis unit analyzes recipes or cooking videos using AI and understands the ingredients and cooking procedures of each dish. For example, image analysis technology is used to analyze the content of cooking videos and extract ingredients and cooking procedures. Text analysis technology may also be used to analyze the content of recipes and extract ingredients and cooking procedures.
Step 2: The generation unit generates ingredients and cooking procedures based on information analyzed by the analysis unit. The generation unit automatically generates ingredients and cooking procedures using AI. For example, when a user inputs “I want to make pasta,” AI automatically generates the necessary ingredients and cooking procedures. The generation unit may also store the generated ingredients and cooking procedures in a database for later reference.
Step 3: The provision unit provides information generated by the generation unit to a robot. The provision unit transmits the generated ingredient list and cooking procedures to the robot. For example, information is provided to the robot using a communication protocol.
Step 4: The cooking unit performs cooking based on information provided by the provision unit. The cooking unit prepares ingredients and performs cooking using a robot. For example, ingredients are prepared based on the ingredient list generated by AI, and cooking is performed according to the cooking procedures.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT® (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned analysis unit, generation unit, provision unit, cooking unit, collection unit, storage unit, and output unit is implemented by at least one of, for example, the smart device 14 and the data processing apparatus 12. For example, the analysis unit is implemented by a control unit 46A of the smart device 14 or a specific processing unit 290 of the data processing apparatus 12. The generation unit is implemented, for example, by the specific processing unit 290 of the data processing apparatus 12. The provision unit is implemented, for example, by the control unit 46A of the smart device 14 or the specific processing unit 290 of the data processing apparatus 12. The cooking unit is implemented, for example, by the control unit 46A of the smart device 14. The collection unit is implemented, for example, by the specific processing unit 290 of the data processing apparatus 12. The storage unit is implemented, for example, by a database 24 of the data processing apparatus 12. The output unit is implemented, for example, by a display 40A of the smart device 14 or the specific processing unit 290 of the data processing apparatus 12. The correspondence between each unit and the device or control unit is not limited to the examples described above, and various modifications are possible.

### Second Embodiment

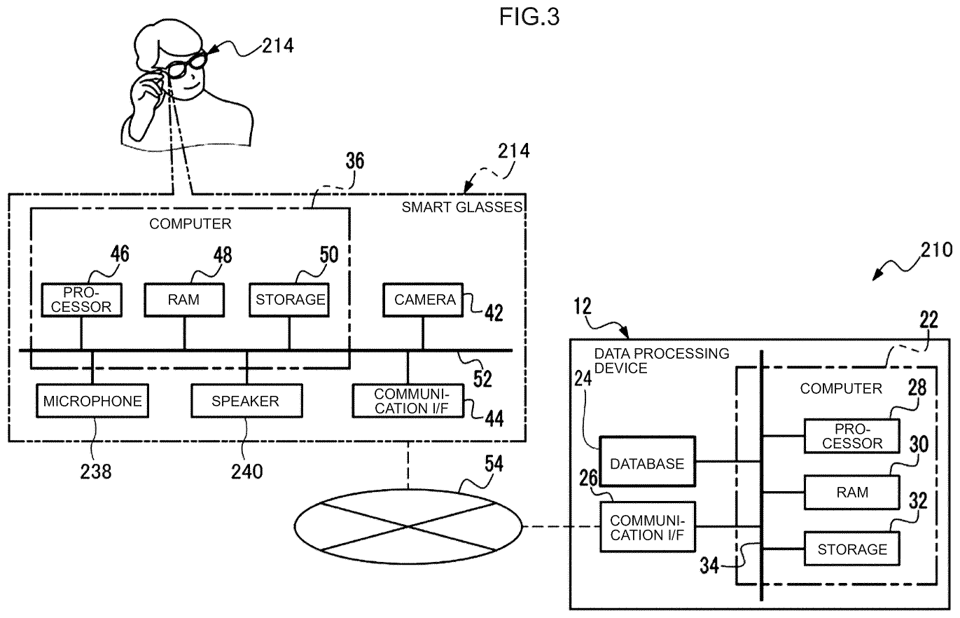

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

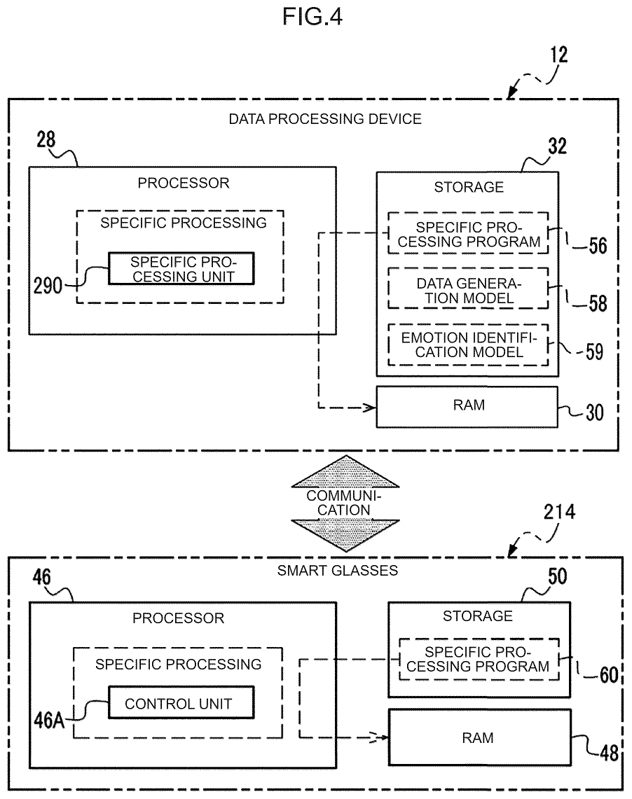

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned analysis unit, generation unit, provision unit, cooking unit, collection unit, storage unit, and output unit is implemented by at least one of, for example, the smart glasses 214 and the data processing apparatus 12. For example, the analysis unit is implemented by a control unit 46A of the smart glasses 214 or a specific processing unit 290 of the data processing apparatus 12. The generation unit is implemented, for example, by the specific processing unit 290 of the data processing apparatus 12. The provision unit is implemented, for example, by the control unit 46A of the smart glasses 214 or the specific processing unit 290 of the data processing apparatus 12. The cooking unit is implemented, for example, by the control unit 46A of the smart glasses 214. The collection unit is implemented, for example, by the specific processing unit 290 of the data processing apparatus 12. The storage unit is implemented, for example, by a database 24 of the data processing apparatus 12. The output unit is implemented, for example, by a display 40A of the smart glasses 214 or the specific processing unit 290 of the data processing apparatus 12. The correspondence between each unit and the device or control unit is not limited to the examples described above, and various modifications are possible.

### Third Embodiment

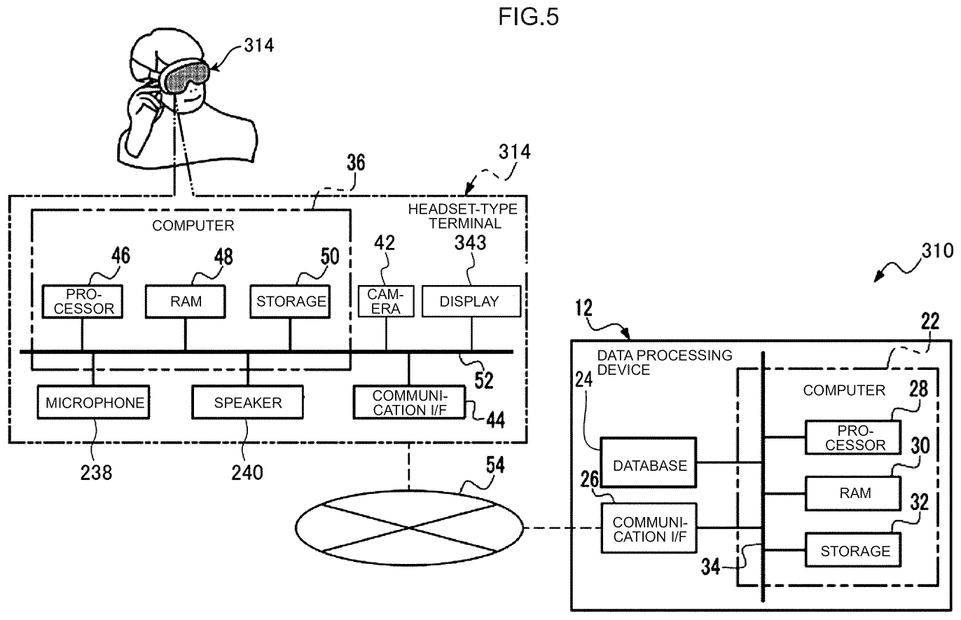

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

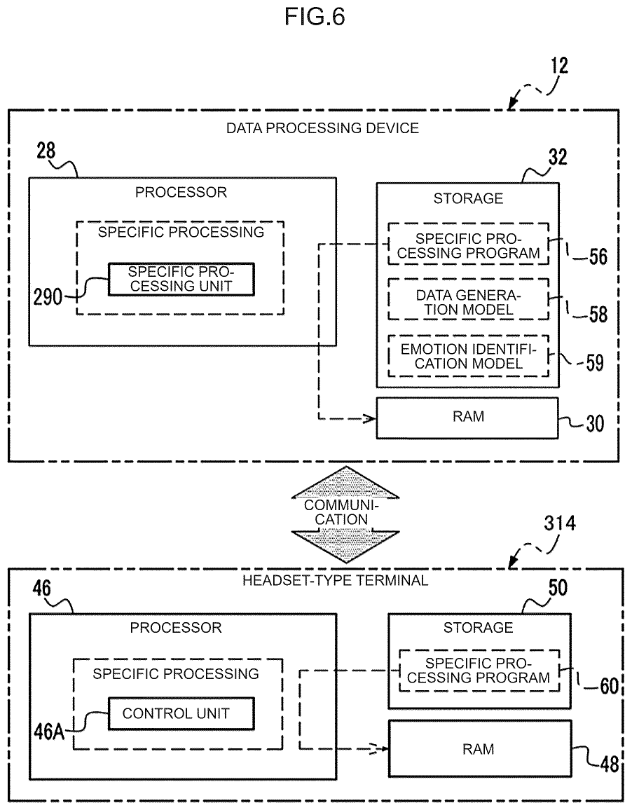

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned analysis unit, generation unit, provision unit, cooking unit, collection unit, storage unit, and output unit is implemented by at least one of, for example, the headset-type terminal 314 and the data processing apparatus 12. For example, the analysis unit is implemented by a control unit 46A of the headset-type terminal 314 or a specific processing unit 290 of the data processing apparatus 12. The generation unit is implemented, for example, by the specific processing unit 290 of the data processing apparatus 12. The provision unit is implemented, for example, by the control unit 46A of the headset-type terminal 314 or the specific processing unit 290 of the data processing apparatus 12. The cooking unit is implemented, for example, by the control unit 46A of the headset-type terminal 314. The collection unit is implemented, for example, by the specific processing unit 290 of the data processing apparatus 12. The storage unit is implemented, for example, by a database 24 of the data processing apparatus 12. The output unit is implemented, for example, by a display 40A of the headset-type terminal 314 or the specific processing unit 290 of the data processing apparatus 12. The correspondence between each unit and the device or control unit is not limited to the examples described above, and various modifications are possible.

### Fourth Embodiment

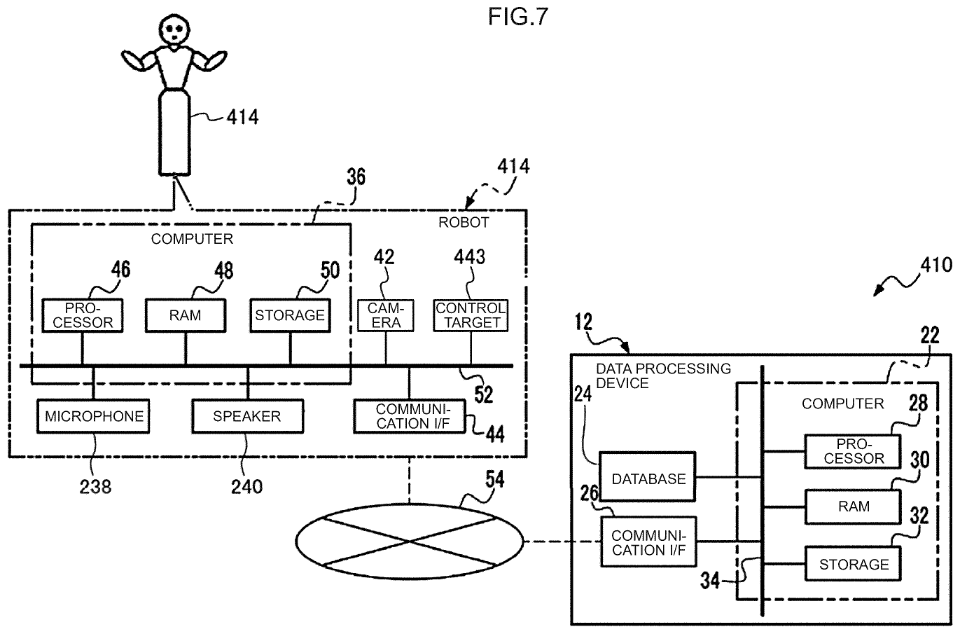

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

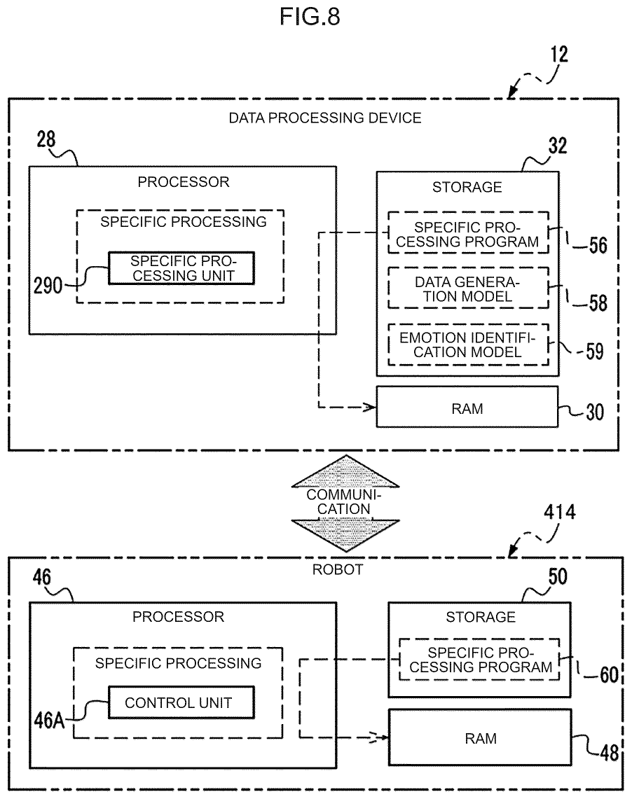

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned analysis unit, generation unit, provision unit, cooking unit, collection unit, storage unit, and output unit is implemented by at least one of, for example, the robot 414 and the data processing apparatus 12. For example, the analysis unit is implemented by a control unit 46A of the robot 414 or a specific processing unit 290 of the data processing apparatus 12. The generation unit is implemented, for example, by the specific processing unit 290 of the data processing apparatus 12. The provision unit is implemented, for example, by the control unit 46A of the robot 414 or the specific processing unit 290 of the data processing apparatus 12. The cooking unit is implemented, for example, by the control unit 46A of the robot 414. The collection unit is implemented, for example, by the specific processing unit 290 of the data processing apparatus 12. The storage unit is implemented, for example, by a database 24 of the data processing apparatus 12. The output unit is implemented, for example, by a display 40A of the robot 414 or the specific processing unit 290 of the data processing apparatus 12. The correspondence between each unit and the device or control unit is not limited to the examples described above, and various modifications are possible.

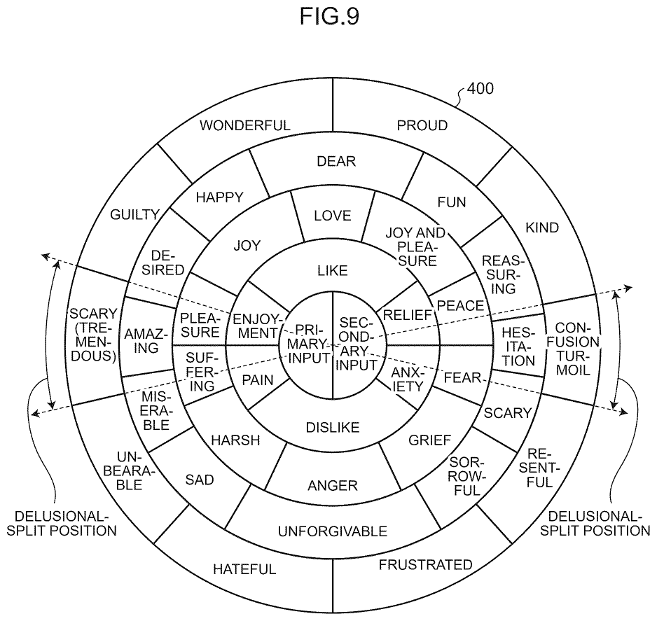

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

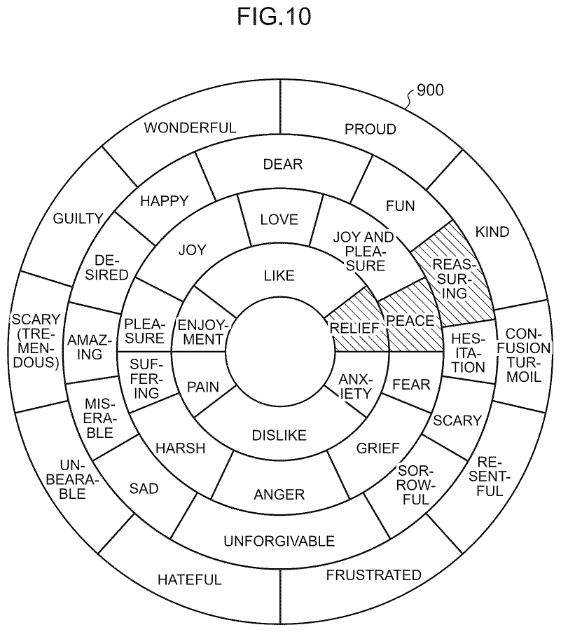

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: an analysis unit configured to analyze a recipe or a cooking video; a generation unit configured to generate ingredients and cooking procedures based on information analyzed by the analysis unit; a provision unit configured to provide information generated by the generation unit to a robot; and a cooking unit configured to perform cooking based on information provided by the provision unit.
(Supplementary Note 2) The system according to Supplementary Note 1, wherein the analysis unit comprises a collection unit configured to collect recipes or cooking videos.
(Supplementary Note 3) The system according to Supplementary Note 1, wherein the generation unit comprises a storage unit configured to store generated ingredients and cooking procedures.
(Supplementary Note 4) The system according to Supplementary Note 1, wherein the cooking unit comprises an output unit configured to provide cooking results to a user.
(Supplementary Note 5) The system according to Supplementary Note 1, wherein the analysis unit is configured to estimate a user's emotion and select recipes or cooking videos to be analyzed based on the estimated emotion of the user.
(Supplementary Note 6) The system according to Supplementary Note 1, wherein the analysis unit is configured to analyze nutritional value and calorie information of recipes during analysis and utilize such information for health management.
(Supplementary Note 7) The system according to Supplementary Note 1, wherein the analysis unit is configured to analyze cultural background and historical information of recipes during analysis and provide such information to the user.
(Supplementary Note 8) The system according to Supplementary Note 1, wherein the analysis unit is configured to estimate a user's emotion and adjust a display method of analysis results based on the estimated emotion of the user.
(Supplementary Note 9) The system according to Supplementary Note 1, wherein the analysis unit is configured to refer to a user's past cooking history during analysis and preferentially analyze recipes that match the user's preferences.
(Supplementary Note 10) The system according to Supplementary Note 1, wherein the analysis unit is configured to preferentially analyze recipes according to the season or weather during analysis.
(Supplementary Note 11) The system according to Supplementary Note 1, wherein the generation unit is configured to estimate a user's emotion and adjust ingredients and cooking procedures to be generated based on the estimated emotion of the user.
(Supplementary Note 12) The system according to Supplementary Note 1, wherein the generation unit is configured to generate ingredients in consideration of the user's allergy information during generation.
(Supplementary Note 13) The system according to Supplementary Note 1, wherein the generation unit is configured to generate ingredients in consideration of the user's ingredient inventory information during generation.
(Supplementary Note 14) The system according to Supplementary Note 1, wherein the generation unit is configured to estimate a user's emotion and adjust the difficulty level of recipes to be generated based on the estimated emotion of the user.
(Supplementary Note 15) The system according to Supplementary Note 1, wherein the generation unit is configured to generate ingredients in consideration of the user's dietary restrictions during generation.
(Supplementary Note 16) The system according to Supplementary Note 1, wherein the generation unit is configured to customize cooking procedures based on the user's dietary preferences during generation.
(Supplementary Note 17) The system according to Supplementary Note 1, wherein the provision unit is configured to estimate a user's emotion and adjust a format of information to be provided based on the estimated emotion of the user.
(Supplementary Note 18) The system according to Supplementary Note 1, wherein the provision unit is configured to select an optimal provision timing based on the user's schedule during provision.
(Supplementary Note 19) The system according to Supplementary Note 1, wherein the provision unit is configured to select an optimal provision method in consideration of the user's device information during provision.
(Supplementary Note 20) The system according to Supplementary Note 1, wherein the provision unit is configured to estimate a user's emotion and determine a priority of information to be provided based on the estimated emotion of the user.
(Supplementary Note 21) The system according to Supplementary Note 1, wherein the provision unit is configured to customize provision contents by referring to the user's past feedback during provision.
(Supplementary Note 22) The system according to Supplementary Note 1, wherein the provision unit is configured to adjust provision contents in consideration of the user's geographic location information during provision.
(Supplementary Note 23) The system according to Supplementary Note 1, wherein the cooking unit is configured to estimate a user's emotion and adjust a cooking progress speed based on the estimated emotion of the user.
(Supplementary Note 24) The system according to Supplementary Note 1, wherein the cooking unit is configured to monitor temperature and humidity in real time during cooking and maintain an optimal cooking environment.
(Supplementary Note 25) The system according to Supplementary Note 1, wherein the cooking unit is configured to monitor a state of cooking utensils during cooking and perform maintenance as needed.
(Supplementary Note 26) The system according to Supplementary Note 1, wherein the cooking unit is configured to estimate a user's emotion and notify a cooking progress status based on the estimated emotion of the user.
(Supplementary Note 27) The system according to Supplementary Note 1, wherein the cooking unit is configured to customize a finished state of cooking according to the user's preferences during cooking.
(Supplementary Note 28) The system according to Supplementary Note 1, wherein the cooking unit is configured to monitor aroma and sound during cooking and perform adjustments to obtain optimal cooking results.
(Supplementary Note 29) The system according to Supplementary Note 2, wherein the collection unit is configured to estimate a user's emotion and determine a priority of recipes or cooking videos to be collected based on the estimated emotion of the user.
(Supplementary Note 30) The system according to Supplementary Note 2, wherein the collection unit is configured to refer to a user's past cooking history during collection and preferentially collect recipes that match the user's preferences.
(Supplementary Note 31) The system according to Supplementary Note 2, wherein the collection unit is configured to estimate a user's emotion and adjust categories of recipes to be collected based on the estimated emotion of the user.
(Supplementary Note 32) The system according to Supplementary Note 2, wherein the collection unit is configured to preferentially collect highly relevant recipes in consideration of the user's geographic location information during collection.
(Supplementary Note 33) The system according to Supplementary Note 3, wherein the storage unit is configured to estimate a user's emotion and determine a priority of ingredients and cooking procedures to be stored based on the estimated emotion of the user.
(Supplementary Note 34) The system according to Supplementary Note 3, wherein the storage unit is configured to refer to a user's past cooking history during storage and preferentially store ingredients and cooking procedures that match the user's preferences.
(Supplementary Note 35) The system according to Supplementary Note 3, wherein the storage unit is configured to estimate a user's emotion and adjust a format of information to be stored based on the estimated emotion of the user.
(Supplementary Note 36) The system according to Supplementary Note 3, wherein the storage unit is configured to select an optimal storage method in consideration of the user's device information during storage.
(Supplementary Note 37) The system according to Supplementary Note 4, wherein the output unit is configured to estimate a user's emotion and adjust a display method of cooking results to be output based on the estimated emotion of the user.
(Supplementary Note 38) The system according to Supplementary Note 4, wherein the output unit is configured to select an optimal display method by referring to the user's past feedback during output.
(Supplementary Note 39) The system according to Supplementary Note 4, wherein the output unit is configured to estimate a user's emotion and determine a priority of information to be output based on the estimated emotion of the user.
(Supplementary Note 40) The system according to Supplementary Note 4, wherein the output unit is configured to select an optimal display method in consideration of the user's device information during output.

What is claimed is:

1. A system comprising:
circuitry configured to:
extract feature vectors from structured text data and sequential image frame data by applying a Transformer-based neural network comprising an attention mechanism and a sequence modeling layer to tokenized text sequences and normalized image tensors;
generate structured output data comprising a list component and a procedure sequence component by inputting the feature vectors into a conditional generation model that applies conditional probability distributions over candidate output tokens; and
transmit the structured output data to a client terminal via a packet-switched network using a transport layer communication protocol.

2. The system according to claim 1, wherein the structured text data comprises recipe text data, and the sequential image frame data comprises cooking video frame data.

3. The system according to claim 1, wherein the list component comprises an ingredient list and the procedure sequence component comprises a cooking procedure sequence.

4. The system according to claim 1, wherein the client terminal comprises an autonomous actuator system configured to execute a control sequence based on the structured output data.

5. The system according to claim 1, wherein the circuitry is further configured to collect the structured text data and the sequential image frame data from an external data source via a representational state transfer application programming interface.

6. The system according to claim 1, wherein the circuitry is further configured to store the structured output data in a database with associated metadata comprising a user identifier and a timestamp.

7. The system according to claim 1, wherein the circuitry is further configured to generate result data indicating a completion status of the control sequence executed by the client terminal, and transmit the result data to a user device via the packet-switched network.

8. The system according to claim 1, wherein the circuitry is further configured to:
acquire multimodal sensor data comprising image data from a camera, audio waveform data from a microphone, and biometric time-series data from a physiological sensor;
extract emotion feature vectors from the multimodal sensor data by applying a convolutional neural network to the image data and a recurrent neural network to the audio waveform data and the biometric time-series data;
compute an emotion classification label and a continuous emotion score by integrating the emotion feature vectors in a multimodal fusion layer and applying a classification head comprising a fully connected layer and a softmax function; and
select the structured text data and the sequential image frame data to be processed based on the emotion classification label.

9. The system according to claim 1, wherein the circuitry is further configured to:
compute a nutritional value vector for the list component by matching each element of the list component against a nutrition reference database; and
generate a health management score based on the nutritional value vector and user profile data.

10. The system according to claim 1, wherein the circuitry is further configured to extract cultural background data and historical information data associated with the structured text data by applying a natural language processing model to an external knowledge database, and append the cultural background data to the structured output data.

11. The system according to claim 8, wherein the circuitry is further configured to adjust a display layout of analysis result data based on the emotion classification label, wherein the display layout is selected from a set of predefined layout templates each associated with a respective emotion classification label.

12. The system according to claim 1, wherein the circuitry is further configured to retrieve historical processing data associated with a user identifier from a database and preferentially process structured text data that matches preference parameters derived from the historical processing data.

13. The system according to claim 1, wherein the conditional generation model is further configured to receive constraint data comprising at least one of allergy information, inventory information, or dietary restriction information, and exclude output tokens corresponding to elements that conflict with the constraint data.

14. The system according to claim 8, wherein the circuitry is further configured to adjust a difficulty parameter of the procedure sequence component based on the continuous emotion score, wherein the difficulty parameter comprises at least one of a step count, a time duration, or a skill level indicator.

15. The system according to claim 1, wherein the circuitry is further configured to determine a transmission timing for the structured output data based on schedule data retrieved from a calendar application associated with a user identifier.

16. The system according to claim 1, wherein the circuitry is further configured to select a data format for the structured output data based on device attribute data associated with the client terminal, the device attribute data comprising at least one of a screen size, a resolution, or an interface type.

17. The system according to claim 1, wherein the circuitry is further configured to:
acquire sensor data from the client terminal during execution of the control sequence, the sensor data comprising at least one of temperature data, weight data, or image data; and
generate an anomaly detection label and a progress score by inputting the sensor data into an anomaly detection model comprising a long short-term memory network.

18. A system comprising:
circuitry configured to:
preprocess structured text data by tokenizing the structured text data into a token sequence of up to 4096 tokens, and preprocess sequential image frame data by resizing each image frame to a 224×224 pixel RGB image tensor and normalizing pixel values;
extract text feature vectors from the token sequence by applying a Transformer encoder comprising a multi-head attention mechanism, and extract image feature vectors from the normalized image tensors by applying a convolutional neural network comprising a feature extraction layer;
extract audio feature vectors from audio waveform data sampled at 16 kHz by computing mel-frequency cepstral coefficients and applying a recurrent neural network;
analyze temporal flow of procedure steps and relationships among list elements in a high-dimensional feature space by applying an attention mechanism to the text feature vectors, the image feature vectors, and the audio feature vectors;
generate structured output data comprising a list component and a procedure sequence component by inputting the text feature vectors and the image feature vectors into a conditional Transformer model that applies conditional probability distributions over candidate output tokens, the conditional Transformer model further receiving constraint parameters comprising at least one of user preference data, inventory data, or restriction data; and
transmit the structured output data and a set of control commands derived from the procedure sequence component to a client terminal via a packet-switched network using a transport layer communication protocol.

19. The system according to claim 18, wherein the circuitry is further configured to acquire real-time sensor data from the client terminal during execution of the control commands, the real-time sensor data comprising temperature time-series data, weight measurement data, and image tensor data, and generate an anomaly detection flag, a progress score, and an estimated completion time by inputting the real-time sensor data into an autoencoder-based anomaly detection model and a long short-term memory prediction model.

20. A method performed by circuitry of a system, the method comprising:
extracting feature vectors from structured text data and sequential image frame data by applying a Transformer-based neural network comprising an attention mechanism and a sequence modeling layer to tokenized text sequences and normalized image tensors;
generating structured output data comprising a list component and a procedure sequence component by inputting the feature vectors into a conditional generation model that applies conditional probability distributions over candidate output tokens; and
transmitting the structured output data to a client terminal via a packet-switched network using a transport layer communication protocol.
